(19) United States
(12) Patent Application Publication
(10) Pub. No.: US 2018/0065447 A1
(43) Pub. Date: Mar. 8, 2018

(54) ELECTRIC HEATER

(71) Applicant: MAHLE International GmbH, Stuttgart (DE)

(72) Inventors: Alain CMELIK, Willer-sur-Thur (FR); Michael KOHL, Bietigheim-Bissingen (DE); Karl-Gerd KRUMBACH, Burgstetten (DE); Wolfgang SEEWALD, Tamm (DE)

(73) Assignee: MAHLE International GmbH, Stuttgart (DE)

(21) Appl. No.: 15/696,577

(22) Filed: Sep. 6, 2017

(30) Foreign Application Priority Data
Sep. 6, 2016 (EP) 16187359.1

(51) Int. Cl. B60H 1/22; F24H 9/18

(52) U.S. Cl. CPC B60H 1/2221; F24H 9/1827; B60H 2001/2296; B60H 2001/2271; B60H 1/2225

(57) ABSTRACT

An electric heating device having a housing with a fluid inlet and with a fluid outlet, wherein the housing can be flowed through by a fluid, and wherein a number of heating elements protrude into the interior of the housing, wherein the heating elements have a heating element housing, and wherein a heating element has at least one heater in the heating element housing and the at least one heater has contacting contact elements and an electrical insulation for insulating the contact elements from the heating element housing, wherein the heating elements are sealingly connected with their heating element housing to the housing, wherein the heater of the heating elements are arranged in a geometrical configuration between the contact elements.

This nonprovisional application claims priority under 35 U.S.C. §119(a) to European Patent Application No. 16187359.1, which was filed in Europe on Sep. 6, 2016, and which is herein incorporated by reference.

### BACKGROUND OF THE INVENTION

### Field of the Invention

The invention relates to an electric heating device, in particular for heating an interior of a motor vehicle.

### Description of the Background Art

Motor vehicles usually have a heatable interior. For this purpose, motor vehicles with an internal combustion engine usually have a heating heat exchanger connected in the cooling circuit, through which hot coolant, which is heated by the internal combustion engine, flows. As a result, the air flowing through the heating heat exchanger can be heated and supplied to the interior space.

In particular, motor vehicles with fuel-efficient combustion engines that generate less waste heat and motor vehicles with plug-in/range extenders require auxiliary heaters for heating the interior. Motor vehicles with an electric drive require heating devices because heating from the coolant warmed by the internal combustion engine that normally takes place does not occur due to the fact that there is no combustion engine.

Particularly in the starting phase and/or at low outside temperatures, heating or auxiliary heating is desired or necessary.

For this purpose, different heating devices or auxiliary heaters have become known, such as, for example, electric auxiliary heaters, heat pump devices, fuel-powered heaters, as well as heating by means of exhaust gas heat exchangers.

The electrical auxiliary heater has the advantage that the electric heating devices required for this are relatively inexpensive as compared to other solutions, and that the generated heat is relatively spontaneously noticeable because the electrical power is converted almost immediately into tangible heat. Furthermore, electric heating devices are space-saving and thus can be installed in a variety of ways in a motor vehicle.

For hybridized vehicles or purely electrically operated vehicles, the role of the electric heater or auxiliary heater is even greater since heating by means of waste heat from the internal combustion engine is not possible. In such motor vehicles, electrical power of approximately more than 3 kW is required. This also means that a high power density is advantageous. In the case of such motor vehicles, the electrical system voltage is usually more than 60 volts, in some cases even more than 300 volts. Due to the high required heating capacities at the (auxiliary) heater, this electric heating device is also operated at the high voltage so as to keep the amperage during operation as low as possible.

Such a heater or auxiliary heater as a heating device for high-voltage applications, that is to say for voltages above 60 volts, must be designed in such a way that hazards arising from the heating device during operation or maintenance can be eliminated.

In the case of electric heating devices as auxiliary heaters or as sole heaters, there is generally the possibility that the electrical power is guided directly into a liquid medium, for example a coolant, which emits the heat into the interior of the vehicle via a further heat exchanger. Such a heating device is also referred to as a coolant-side heating device.

There is also the possibility that the electrical power is delivered to the air and that this heated air is used to heat the interior. Such a heating device is also referred to as an air-side heating device.

The air-side heating devices are more spontaneous in terms of time, since nearly one hundred percent of the electric energy is converted to air heating. The degree of effectiveness is almost one hundred percent. However, it can reasonably only be used for heating the interior of the vehicle cabin. Likewise, for logical reasons, it is integrated in the vehicle interior, i.e., in the air conditioning unit. However, integrating a high-voltage component in the interior is complicated in terms of safety and usually involves a more complex design of the air conditioning system, which increases cost.

The heating device on the coolant side is not quite as spontaneous and efficient in its heating effect since the electrical energy is first used to heat up the fluid, for example in a small water circuit. The heated fluid or water is used in a separate coolant/air heat exchanger, such as in a motor vehicle with an internal combustion engine, in order to heat the air flowing into the interior space.

There is preferably no high-voltage component in the interior of the motor vehicle. It is also advantageous in this configuration that the coolant-side heating device can be installed in the motor vehicle at different locations outside the interior space. The air conditioning system can be used the same way as in a traditional motor vehicle without the need for major structural changes. A further advantage of the coolant-side heating device is the possibility of being able to heat or reheat a battery, for example in the case of a pure electric vehicle, by means of the hot water or by means of the coolant.

Various coolant-side heating devices have become known in the prior art. DE 10 2010 060 446 A1, which corresponds to U.S. Pat. No. 9,167,629, and which discloses a resistance heater with a helical heating coil in a coolant-permeated housing. In this heating coil there is a heating wire which is also helical. The voltage drop or current flow occurs along this helically wound heating wire. However, the construction is very complex and thus also expensive to produce.

Heating devices with PTC heating elements are also known, which are energized by way of contact electrodes, see EP 1 872 986 A1, which corresponds to U.S. Pat. No. 8,946,599. The heating elements supply their heat only indirectly to the coolant since the heating unit consisting of heating elements and contact electrodes is electrically insulated. The heat must travel at least through the electrical insulation of poorly thermally conductive materials and through the housing of the coolant-carrying duct in order to heat the coolant. The housing is a fairly massive cast body that has U-shaped recesses which project into the fluid chambers. The coolant then flows around the U-shaped recesses in a meandering manner. The heating elements, which are insulated on both sides, are located in these fluid chambers. The heating unit consisting of PTC heating elements and contact electrodes is then pressed into the U-shaped recesses with an aluminum clamping wedge. Due to this pressing, the electrical contacting between PTC heating elements and contact electrodes, and the thermal contacting between the heating unit and the U-shaped recess, takes place. Such heating devices are also known from EP 2 637 475 A1 and from EP 2 440 004 B1, which corresponds to U.S. Pat. No. 9,161,391.

The heating devices according to the prior art also have disadvantages.

The resistance heaters on the coolant side contain no intrinsic safety of the heating unit concerning an increase in temperature. Therefore, temperature monitoring and a corresponding shutdown are necessary, for example, in the event of a sudden stoppage of the coolant volume flow.

The PTC heaters on the coolant side usually have a high number of heating units, which has two contact electrodes and PTC heating elements and insulations. This results in a rather high assembly effort. The cast housings result in heavy and large designs.

### SUMMARY OF THE INVENTION

It is therefore an object of the invention to provide an electric heating device which is simple and inexpensive to manufacture in comparison to the prior art and is nevertheless improved in comparison to the prior art.

An exemplary embodiment of the invention relates to an electric heating device comprising a housing with a fluid inlet and a fluid outlet, the housing being able to be flowed through by a fluid, and a number of heating elements projecting into the interior of the housing, the heating elements comprising a heating element housing, a heating element in the heating element housing comprising at least one heater and the at least one heater comprising contacting contact elements and an electrical insulation to insulate the contact elements from the heating element housing, wherein the contact elements protrude out of the heating element and wherein the heating elements are sealingly connected with their heating element housing to the housing, wherein the heater of the heating elements are disposed between the contact elements in a geometrical arrangement. As a result, the heat generated by the heater can be distributed as effectively and uniformly as possible to the surface of the heating element so that the fluid flowing through the housing can be heated as effectively as possible.

According to an embodiment, it is also advantageous if a heater has a substantially two-dimensional shape and the heater are arranged in rows and columns. In this case, a substantially two-dimensional shape means that the extent of thickness is smaller than an extent in the surface perpendicular to the direction of thickness, so for example, the thickness direction is at most half of a dimension in the surface, advantageously only one-fifth or only one-tenth of a dimension in the surface. By arranging the heater in rows and columns, the area which is heated can be increased so that the heat transfer to a fluid surrounding the heating element is improved.

According to a further idea, it is also advantageous if the heater of a heating element are arranged in at least one column and at least one row. As a result, depending on the embodiment, the heat can be generated over a large area or in columns and/or rows and can be delivered to the fluid, which allows for good controllability of the heat.

It is also advantageous if the heater of a heating element are arranged in at least N columns and at least M rows with N=1, 2, 3, 4, 5, 6, 7, 8, 9, 10 etc. and with M=0, 1, 2, 3, 4, 5, 6, 7, 8, 9, 10 etc. Depending on the embodiment and dimensioning of the heating device or the heating elements, the heater can be arranged differently in rows and columns in order to address the available installation space and the desired controllability.

It is also convenient if the heater of a heating element are arranged in 5 columns and in 4 rows or in 1 column and in 5 rows or in 3 columns and in 5 rows or in 2 columns and in 6 rows or in 4 columns and in 4 rows or in 4 columns and in 3 rows or in 7 columns and in 2 rows. This results in advantageous arrangements for a two-dimensional heating element.

Likewise, it is expedient for the contact elements to be embodied in a two-dimensional manner, wherein each of the heater is contacted on both sides by a contact element. As a result, all or only parts of the heater can be contacted by a pair of contact elements so that they are contacted on both sides in order for a heating current flow to take place.

It is also advantageous if a two-dimensional contact element is designed in such a way that in each case one two-dimensional contact element contacts all the heater of a heating element on one side. As a result, all the heater of a heating element are contacted in parallel so that the heating element can be heated over a large area.

Alternatively, it is advantageous if a two-dimensional contact element is designed in such a way that a respective two-dimensional contact element contacts all heater of at least one column and/or at least one row of a heating device on one side. As a result, the heater of at least one column and/or at least one row of a heating device are contacted in parallel so that the heating device can be heated in a segmented manner.

It is particularly advantageous if a heater has two contact surfaces which are each contacted by a contact element. As a result, the current flow can be distributed in a targeted manner to the contacted heater.

It is also advantageous if the contact elements have connecting lugs by means of which they protrude from the heating element housing of the heating element.

According to an embodiment, the above-described embodiments can be combined with the following embodiments and optimized.

An exemplary embodiment of the invention also relates to an electric heating device comprising a housing with a fluid inlet and a fluid outlet, wherein the housing can be flowed through by a fluid, and wherein a number of heating elements protrude into the interior of the housing, the heating elements comprising a heating element housing, and wherein a heating element in the heating element housing comprises at least one heater and at least one contact element contacting the at least one heater and an electrical insulation for insulating the contact elements from the heating element housing, the contact elements protruding from the heating element and the heating elements being arranged with their heating element housing so as to be sealingly connected to the housing, the heating elements being arranged such that they can be flowed around by the fluid on one side or on both sides in the flow direction of the fluid from the fluid inlet to the fluid outlet. This creates a simple and inexpensive electric heating device, which has a good heat transfer to the fluid to be heated.

In an embodiment of the invention, it is particularly advantageous if the heating elements are arranged one behind the other in a flow direction of the fluid, and laterally offset in relation to one another. As a result, the heating elements can be arranged in a kind of zig-zag line so that the fluid to be heated is redirected from heating element to heating element and thus an improved heat transfer is achieved due to the accompanying fluid mixture.

In an exemplary embodiment, it is also advantageous if the heating elements are arranged in the flow direction of the fluid in at least one column or in a plurality of columns one behind the other and laterally offset in relation to each other. As a result, depending on the width of the heating device, the respective fluid path around the heating elements or between the heating elements can be optimally adapted so that the heat transfer is favorable with acceptable pressure drop. If the installation space is rather narrow, for example, only one heating element can be provided in the lateral width, which then preferably is greater in length in the flow direction. If the installation space is larger, for example, a plurality of heating elements may be provided in the lateral width, which may then also be smaller in length in the direction of flow.

It is also advantageous if flow guidance elements project from the housing into the interior of the housing, or if flow guidance elements, which influence the flow of the fluid, are arranged in the interior of the housing, in particular directing the flow of the fluid towards the laterally offset heating elements. As a result, the fluid flow is preferably directed to where the heating elements are arranged. The cross section of the interior of the housing of the heating device is thereby locally reduced, and the fluid flow is directed towards the heating element or the heating elements. The heat transfer to the fluid is thereby improved.

It is also advantageous if a flow guidance element is arranged in each case adjacent to a heating element and reduces the flow cross section for the fluid that is adjacent to the heating element. As a result, the cross section of the interior of the housing is advantageously reduced at the level of the heating element in the direction of flow, and the fluid is directed towards the heating element or the heating elements.

It is also advantageous if the heating elements are arranged laterally next to one another in columns in a flow direction of the fluid so that the fluid can pass between the columns. As a result, the fluid can simultaneously flow past the heating elements along a plurality of substantially parallel paths and be heated up. This increases the level of effectiveness of the heat transfer of the electric heater.

Thus, it is also advantageous if the heating elements of a column or in several columns are arranged successively adjacent to one another, and preferably next to one another in the flow direction. As a result, the fluid can be heated in its direction of flow by a plurality of heating elements arranged one after the other and, if appropriate, by several such columns, which are preferably arranged next to one another.

It is also advantageous if the heating elements of a column are arranged one after the other in the flow direction and at a distance from each other. As a result, through the distance between the heating elements, a mixing can take place at every distance, so that the fluid is gradually heated on each heating element, and a mixing takes places at the distances of the heating elements, so that the fluid has about the same temperature on either side of a heating element, or that the temperature differences on either side of a heating element are not so great.

It is also advantageous if the heating elements have an extension in the direction of flow which is greater than an extension transverse to the flow direction, viewed in a plane parallel to the wall with the openings into which the heating elements are inserted. This means that the heating elements are arranged essentially in the flow direction or along the flow direction between the fluid inlet and the fluid outlet. As a result, the heating elements can be designed larger and can also be used for fluid separation.

It is also advantageous if the heating elements have an extension in the direction of flow which is smaller than an extension transverse to the flow direction, viewed in a plane parallel to the wall with the openings into which the heating elements are inserted. This means that the heating elements are arranged essentially transverse to the flow direction, or transverse to the flow direction between the fluid inlet and the fluid outlet. As a result, the heating elements can serve as barriers and deflect the fluid in order to extend the fluid path within the housing between the fluid inlet and the fluid outlet.

It is also expedient if the heating elements bear against a side wall of the housing or are attached thereto. This ensures that the fluid cannot flow between the side wall of the housing and the heating element, but must flow around the heating element. This extends the fluid path so that the fluid can be heated along a longer fluid path.

It is likewise advantageous if respective, in particular alternating, heating elements bear against or are fastened to opposite side walls of the housing. This way, a zigzag-shaped fluid path is formed, which brings about an improved heating.

Furthermore, it is also advantageous if at least one partition is arranged in the interior of the housing, which divides the interior of the housing into a plurality of fluid paths, which are flowed through in series by the fluid. As a result, the fluid path can additionally be lengthened or modulated in order to be able to heat the fluid in a longer path.

According to an embodiment, it is advantageous if the heating elements are arranged in the interior of the housing in such a way that they divide the interior of the housing into a plurality of fluid paths, which are flowed through in series by the fluid. As a result, the fluid path is also lengthened in order to be able to heat the fluid better on a longer path.

It is also advantageous if the heating elements are arranged such that at least individual heating elements are arranged in at least one of the fluid paths, or at least individual heating elements are arranged in each of the fluid paths, or the fluid paths are guided past at least one of the heating elements.

An exemplary embodiment according to the invention also relates to an electric heating device comprising a housing with a fluid inlet and a fluid outlet, a number of openings being provided in a wall into which heating elements are inserted and which project into the interior of the housing, the heating elements having a heating element housing, and wherein a heating element in the heating element housing has at least one heater and the at least one heater has contacting contact elements and an electrical insulation for insulating the contact elements from the heating element housing, the contact elements projecting from the heating element, and wherein the heating elements with their heating element housing are inserted into the openings of the housing such that the heating element housing is sealingly connected to the housing. As a result, the respective heating element can project into the housing, which is flowed through by the fluid to be heated, wherein nevertheless a simple and inexpensive design is achieved.

It is particularly advantageous if the heating element housing is sealingly connected to the housing by means of a thermal joining process, such as by welding and/or soldering and/or adhesive bonding. This ensures that the connection between the heating element housing and the housing is stable and permanently tight in order to achieve the necessary operational safety.

It is also advantageous if the heating elements are encapsulated in such a way that the heating element housing is sealingly closed, except for a passage for the contact elements. As a result, the heating element housing is sealed to the outside to the fluid to be heated, and nevertheless the contact elements can be guided out of the heating element housing in order to supply the current to the heater. The contact elements are, however, separated and sealed off from the fluid to be heated.

It is also advantageous if the contact elements are passed through the passage in a sealed manner. It is thus achieved that even inadvertently occurring fluid in the region of the contact elements cannot penetrate the heating device.

It is also particularly advantageous if the heating element housing is formed from a tube open on one side, a deep-drawn or extruded tube element or two shells, such as half-shells. As a result, it can be achieved that the heating element housing is quasi closed on all sides and has an opening only for the passage of the contact elements.

In an embodiment, it is advantageous if the at least one heater and the contact elements contacting the at least one heater and the electrical insulation are inserted into the heating element housing as a preassembled unit. As a result, the assembly can be considerably simplified and fewer errors are caused by, for example, an insulation not properly performed. After the insertion, the heating element housing can then also be compressed or deformed in order to hold the inserted elements or the preassem bled unit therein in a form-locking manner.

It is also advantageous if the housing is designed to be at least two-part and has a base with the openings for receiving the heating elements and of at least one further housing part. As a result, the heating device can be produced more easily, for example by thermoforming individual housing parts of the housing, the housing parts of the housing being subsequently connected in a sealed manner in order to seal the fluid-permeated interior. This can be done, for example, by soldering, welding or bonding or by arranging a seal and by crimping or by a corrugated slot flanging.

It is particularly advantageous if the housing is designed to be at least two-part and has a base with openings for receiving the heating elements, and of at least one further housing part. In this case, the base can be two-dimensional, and the other housing part can be trough-like. Also, the base may be curved, such as, for example, trough-shaped. In this case, the other housing part could also be two-dimensional.

It is also particularly advantageous if, furthermore, an electronic control unit is provided, which contacts the contact elements of the heating elements, wherein the control unit can be connected to the base. As a result, the heating device and the electronic control unit can be compactly manufactured as a unit and installed together in the motor vehicle, for example in the engine compartment.

For an improved heat transfer and an adapted pressure drop of the fluid to be heated, it is advantageous if a deflector is provided in the housing, which deflect a fluid flow between the fluid inlet and the fluid outlet. As a result, the flow path of the fluid to be heated is deflected and, in particular, also lengthened in order to achieve an improved heat transfer at an acceptable pressure drop.

It is advantageous if the heating element housing is formed from two shells, in particular half shells.

Also, it is advantageous if the heating element housing is sealingly connected to the housing by a thermal joining process, such as by welding, soldering, and/or adhesive bonding.

Furthermore, it is advantageous if the at least one heater has or is a PTC element.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic sectional view of an exemplary embodiment of an electric heating device according to the invention,

FIG. 2 is a schematic sectional view of an exemplary embodiment of an electric heating device according to the invention,

FIG. 3 is a view of a section through a heating element,

FIG. 4 is a schematic partial view of an exemplary embodiment of an electric heating device according to the invention,

FIG. 5 is a schematic partial view of an exemplary embodiment of an electric heating device according to the invention,

FIG. 6 is a view of a section through a heating element,

FIG. 7 is a schematic sectional view of an exemplary embodiment of an electric heating device according to the invention,

FIG. 8 is a schematic partial view of an exemplary embodiment of an electric heating device according to the invention,

FIG. 9 is a schematic partial view of an exemplary embodiment of an electric heating device according to the invention,

FIG. 10 is a schematic partial view of an exemplary embodiment of an electric heating device according to the invention,

FIG. 11 is a view of a section through a heating element,

FIG. 12 is a view of a section through a heating element,

FIG. 13 is a view of a section through a heating element,

FIG. 14 is a schematic partial view of a further exemplary embodiment of an electric heating device according to the invention,

FIG. 15 is a schematic partial view of an exemplary embodiment of an electric heating device according to the invention,

FIG. 16 is a view of a section through a heating element,

FIG. 17 is a schematic partial view of an exemplary embodiment of an electric heating device according to the invention,

FIG. 18 is a schematic partial view of an exemplary embodiment of an electric heating device according to the invention,

FIG. 19 is a schematic partial view of an exemplary embodiment of an electric heating device according to the invention,

FIG. 20 is a schematic partial view of an exemplary embodiment of an electric heating device according to the invention,

FIG. 21 is a schematic sectional view of an exemplary embodiment of an electric heating device according to the invention,

FIG. 22 is a schematic sectional view of an exemplary embodiment of an electric heating device according to the invention,

FIG. 23 is a schematic sectional view of an exemplary embodiment of an electric heating device according to the invention,

FIG. 24 is a schematic sectional view of an exemplary embodiment of an electric heating device according to the invention,

FIG. 25 is a schematic sectional view of an exemplary embodiment of an electric heating device according to the invention,

FIG. 26 is a schematic sectional view of an exemplary embodiment of an electric heating device according to the invention,

FIG. 27 is a schematic partial view of an exemplary embodiment of an electric heating device according to the invention,

FIG. 28 is a schematic partial view of an exemplary embodiment of an electric heating device according to the invention,

FIG. 29 is a view of a section through a heating element,

FIG. 30 is a schematic partial view of an exemplary embodiment of an electric heating device according to the invention,

FIG. 31 is a schematic partial view of an exemplary embodiment of an electric heating device according to the invention,

FIG. 32 is a schematic sectional view through a heating device according to the invention,

FIG. 33 is a schematic sectional view through a heating device according to the invention,

FIG. 34 is a schematic sectional view through a heating device according to the invention,

FIG. 35 is a schematic sectional view through a heating device according to the invention,

FIG. 36 is a schematic sectional view through a heating device according to the invention,

FIG. 37 is a schematic sectional view through a heating device according to the invention,

FIG. 38 is a schematic side view of a heating element,

FIG. 39 is a schematic view of a heating element from above,

FIG. 40 is a schematic sectional view of a heating element,

FIG. 41 is a view of the arrangement of heater,

FIG. 42 is a view of the arrangement of heater,

FIG. 43 is a view of the arrangement of heater,

FIG. 44 is a view of a heating device according to the invention,

FIG. 45 is a partial view of a heating device according to the invention,

FIG. 46 is a partial view of a heating device according to the invention,

FIG. 47 is a partial view of a heating device according to the invention,

FIG. 48 is a partial view of a heating device according to the invention,

FIG. 49 is a partial view of a heating device according to the invention,

FIG. 50 is a view of an arrangement of heating elements of a heating device according to the invention,

FIG. 51 is a view of an arrangement of a heating element of a heating device according to the invention,

FIG. 52 is a side view of a heating element of a heating device according to the invention,

FIG. 53 is an enlarged section of FIG. 52,

FIG. 54 is a side view of a heating element of a heating device according to the invention,

FIG. 55 is a partial view of a heating element of a heating device according to the invention,

FIG. 56 is a partial view of a heating element of a heating device according to the invention,

FIG. 57 is a schematic view of a heating element of a heating device according to the invention,

FIG. 58 is a schematic view of a heating element of a heating device according to the invention,

FIG. 59 is a perspective view of a heating element of a heating device according to the invention,

FIG. 60 is a side view of a heating element of a heating device according to the invention,

FIG. 61 is a view of a contact element of a heating device according to the invention, and

FIG. 62 is a view of an electrical insulation of a heating device according to the invention.

### DETAILED DESCRIPTION

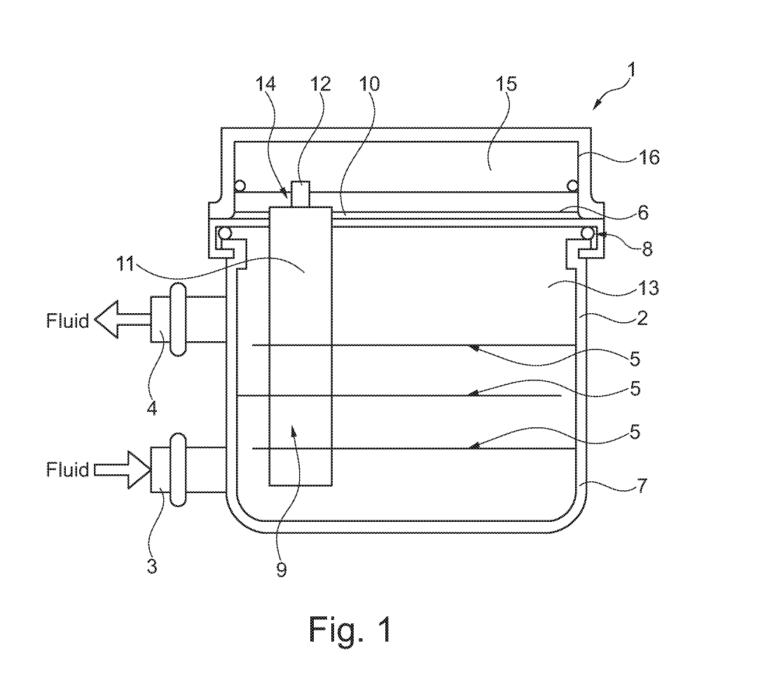

FIGS. 1 to 62 show various views or details of heating devices according to the invention, wherein features of individual embodiments can be combined with one another and also constitute an inventive embodiment.

FIG. 1 shows a schematic view of an electric heating device 1 comprising a housing 2. On the housing 2, a fluid inlet 3 and a fluid outlet 4 is provided so that a fluid to be heated can flow into the housing via the fluid inlet, flow through it and be heated therein, and can flow back out of the housing 2 via the fluid outlet 4. In the housing 2, a deflector 5 may be provided, which deflect the fluid flow of the fluid to be heated in the housing 2 between the fluid inlet 3 and the fluid outlet 4, in order to cause a more favorable heating of the fluid to be heated at a suitable pressure drop. The deflector can be arranged, for example, as baffles to bring about, for example, a meandering flow of fluid through the housing 2.

The housing 2 is advantageously designed in at least two parts, wherein a base 6 and a further housing part 7 are provided, which are sealed together. In this case, the base 6 may be positively connected and sealed with the housing part 7, for example, with the interposition of a seal. This can be done, for example, through a clamp connection or a corrugated slot or flange through a mechanical connection. Alternatively, the base 6 may be connected to the housing part 7 by soldering or welding or by adhesive bonding.

Heating elements 9 project into the interior 13 of the housing, which extend through openings 10 in the base 6, wherein the base 6 as a wall advantageously has a number of openings 10 so that a corresponding number of heating elements 9 can project into the interior 13 of the housing 2. The heating elements 9 are inserted accordingly into the openings 10 of the base 6, the heating elements 9 being sealingly inserted into the base 6. The connection between the heating element 9 and the base 6 in the area of the openings 10 is preferably accomplished by welding, soldering and/or adhesive bonding.

A heating element 9 has at least one heating element housing 11, in which at least one heater 19 or a plurality of heater 19 and the contact element or contact elements 12 contacting the heater 19 and an electrical insulation 20 are arranged. In this case, at least two contact elements 12 are provided which contact the heater 19, with the contact elements 12 being electrically insulated from the heating element housing 11 by means of the insulation 20 provided. For contacting of the contact elements 12, the latter protrude from the heating element 9 or from the heating element housing 11, outside of the interior 13 of the housing 2, from the heating element housing 11.

The heating elements 9 are inserted sealed in the openings 10 of the housing 2 with their heating element housing 11 in such a manner that the housing 2 is sealed. The connection between the heating element housing 11 and the housing 2 can be achieved in a sealed manner by a thermal joining process such as by welding and/or soldering and/or adhesive bonding. This results in a sealed, stable connection between the heating element housing 11 and the base 6 or the housing 2 so that the fluid can flow in the interior 13 of the housing 2 without the heater 19 or the contact elements 12 coming into contact with the fluid. The heating elements 9 are encapsulated accordingly, so that the heating element housing 11 is sealed except for a passage 14 for the contact elements 12. It is also preferred if the contact elements 12 are passed in a sealed manner in the passage 14. This can be done, for example, with the electrical insulation 20 provided or with an additional sealing element.

Preferably, the heating element housing 11 is formed from a tube which is, for example, open on one side to form the passage 14, the other side of the tube being sealed so that the closed portion of the tube can project through the opening 10 in the base 6, into the interior 13 of the housing 2. The heating element housing 11 may, for example, be formed by a deep-drawn or extruded tubular element, a welded or seamed tube, or further formed by a tube produced otherwise.

Alternatively, the heating element housing 11 may be formed by a pocket, which is formed for example of two shells, for example two half shells 52, 53. The formation of the heating element housing 11, for example, by two shells, may preferably occur in that the two shells are peripherally thermally joined together, for example welded, soldered and/or adhesively bonded, so that only the passage 14 remains for the contact elements 12. It may also be advantageous when the passage 14 is also used for the insertion of the heater 19, the contact elements 12 and the electrical insulation 20.

It is particularly preferred if the heater 19 and the contact elements 12 contacting the at least one heater 19 and the electrical insulation 20 are inserted in the heating element housing 11 as a preassembled unit. For this, the pre-assembled unit can be prefabricated in order for the use in an available heating element housing 11.

For controlling the electric heating device 1, an electrical control unit 15 is advantageously provided, which is electrically and/or mechanically connected to the contact elements 12 of the heating elements 9, so that a selective control of the heating elements 9 can be carried out.

The electronic control unit 15 is preferably connected to the base 6 and/or to a control unit housing 16, wherein in the case of connecting the control unit 15 to the control unit housing 16, the control unit housing 16 is advantageously connected to the base 6. This allows for an assembly to be created, which can be arranged space-dependent in the motor vehicle.

In one embodiment of the heating device according to the invention, the respective heating element 9 is in each case encapsulated, so that the respective heating element 9 projects into the interior 13 of the housing 2 traversed by the fluid. Since the respective heating elements 9 are thermally joined to the base 6, the current-carrying parts of the heating elements 9 are spatially and electrically, or galvanically, separated from the fluid flow. Particularly in high voltage applications with voltages greater than 60 volts, this is advantageous.

In production, it can be advantageous if the base 6 and the heating element housing 11 are each prefabricated and are sealingly connected with each other by means of a thermal joining method, see above. Thereafter, the at least one heater 19 can be inserted, or slid, into the heating element housing 11 with the contact elements 12, and the electrical insulation 20, and the heating element housing 11 can be compressed, for example, for the positive connection of the components inserted, so that a favorable thermal contact of elements is generated in the heating element housing 11.

Alternatively, the heating elements 9 may also be prefabricated and only then inserted into the openings of the base 6, and, for example, be connected to the base 6 by means of a thermal joining process.

The heating element housing 11 may, for example, be made by an extruded tube, an extruded part or a deep-drawn part. Alternatively, a welded tube or a folded tube can be used, wherein the heating element housing 11 is pressed after insertion of the heater 19, the contact elements 12 and the electrical insulation 20, in order to improve the thermal contact between the heater 19, the contact elements 12 and the insulation 20 with the heating element housing 11, in order to achieve good heat transfer to the fluid to be heated.

As already stated above, the heating element housing 11 may also be composed of two shells, for example two half shells 52, 53, wherein the electrical insulation 20 with the heater 19 and the contact elements 12 is inserted in this case. The two shells 52, 53 can be joined together, for example, by thermal joining, i.e., welding, adhesive bonding or soldering. The shells are thereby joined with each other, preferably sealed at their edge. Alternatively, the shells or half shells 52, 53 can be joined mechanically, for example, by crimping or otherwise deforming.

The flow through the interior 13 of the housing 2 can be formed in a simple manner or by deflection of the fluid. For this purpose, a deflector may be provided.

The housing 2 may be formed of steel, aluminum or plastic and, for example, have a wall thickness of 1 to 4 mm. The base 6 is preferably made of steel, aluminum or non-ferrous metal, and advantageously has a material thickness of 0.5 to 3 mm. The heating element housing 11 is preferably made of steel, aluminum or non-ferrous metal, and advantageously has a material thickness of 0.2 to 1 mm. The contact elements 12 are preferably constructed as contact plates made of aluminum or non-ferrous metal, and advantageously have a material thickness of 0.2 to 1 mm. Alternative configurations of the housing 2, the base 6, the heating element housing 11 and/or the contact element 12 may also have different dimensions or material thicknesses and materials.

The electric heating device 1 according to the invention is preferably a high voltage heating device for voltages greater than 60 volts or particularly of about 300 volts or more, with a plurality of encapsulated heating elements 9, wherein a greater number of smaller encapsulated heating elements 9 or a smaller number of larger heating elements 9 can be provided.

The elements of the heating elements 9 can be inserted and pressed or glued into the heating element housing 11 or they can be inserted or glued in the shells or half shells 52, 53, wherein the half shells 52, 53 are then, or are previously, joined together in a sealed manner, for example, thermally joined.

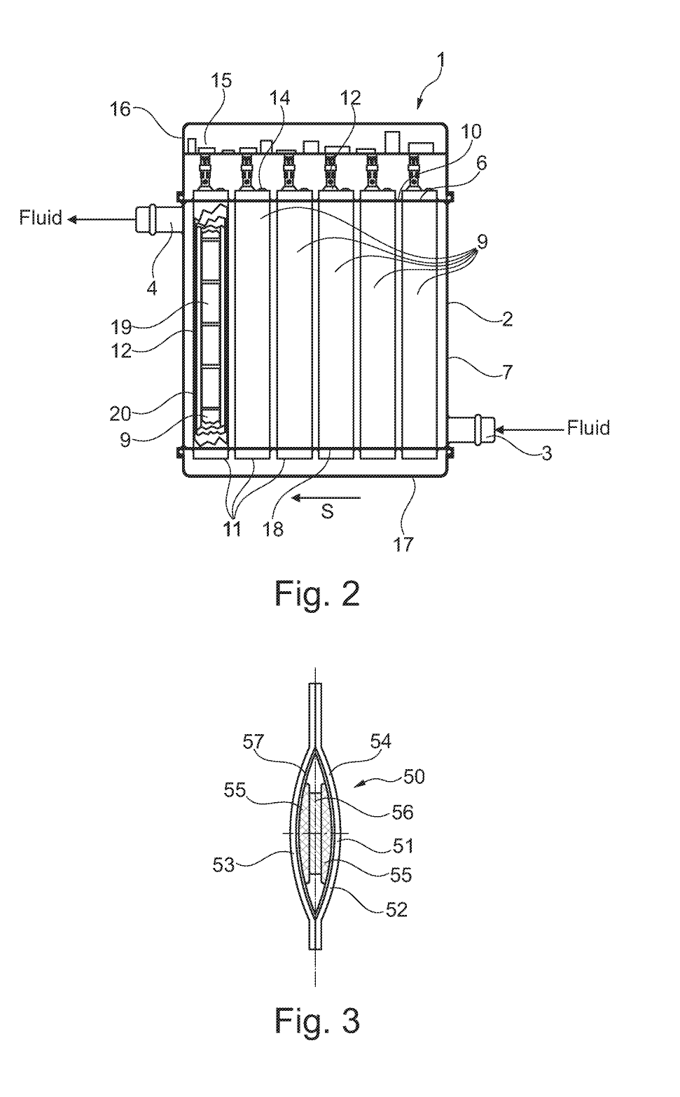

FIG. 2 shows an alternative embodiment of an electric heating device 1 with a plurality of heating elements 9, which are arranged in the flow direction of the fluid in succession, and possibly also side by side in columns. The housing 2 is formed in several parts with a base 6, a further housing part 7, a lower housing cover 17 and with a second base 18. The heating elements 9 can be inserted into the openings 10 of the base 6 and be connected sealed and thermally joined, wherein the heating element housings 11 form a kind of tube matrix that is disposed between the bases 6 and 18, wherein the heating element housings are closed on one side and on the other side have a passage 14 for the contact elements 12.

In FIG. 2, it can be seen that the heater 19 are PTC elements, which are in electrical contact on both sides with the contact members 12, wherein the electrical insulation 20 is disposed around the contact elements 12 and the heater 19 in order to electrically insulate the grouping of the heater 19 and the contact elements 12 from the heating element housing 11. The control unit 15 is electrically connected with the contact elements 12, wherein the control unit housing 16 is mechanically sealed to the base 6.

Instead of PTC heater, other heater may be used. This principle also applies to all other embodiments, the fact that PTC heater or other heater can be used.

In FIG. 2, it can be seen that the fluid inlet 3 is disposed on a different side of the housing 2 than the fluid outlet 4. Without internal the deflector 5, this causes a substantially I-shaped flow through the housing 2. If the deflector 5 is provided, a meandering flow may occur.

FIG. 3 shows an embodiment of a section of a heating element 50, with a heating element housing 51 which includes two half shells 52, 53, which are preferably thermally joined together, for example, welded, soldered and/or adhesively bonded.

The half shells 52, 53 have a passage 54 through which, for example, for electrically contacting a control unit, the contact elements 55 can protrude. In the heating element housing 51, the heater 56, the contact elements 55 on both sides of the latter, and a wrap-around electrical insulation 57 are arranged. The electrical insulation is generally a solid, flexible, thin or thick insulation, which has an electrically non-conductive insulating material. FIG. 3 shows that the heating element is designed bi-convex in section. Other embodiments may be designed to be different, for example, rectangular, oval or round, etc. The bi-convex shape is favorable for the pressure drop of the fluid.

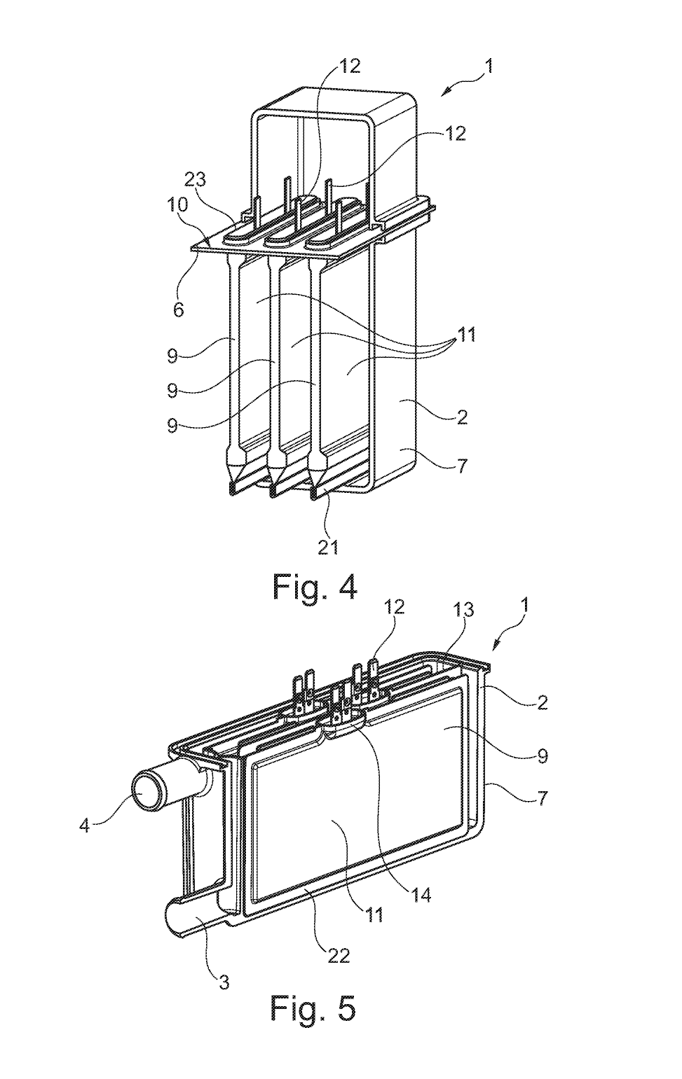

FIG. 4 shows another embodiment of an electric heating device similar to FIG. 1, in a partially sectioned view, wherein the heating elements 9 can be seen with their heating element housings 11. There are three heating elements 9 side by side and spaced apart from each other, as viewed in the flow direction. The heating element housings 11 are inserted at their upper ends in the openings 10 of the base 6, wherein the contact elements 12 project out from the heating elements 9. The heating element housings 11 are formed as tubes closed on one side, wherein the heater, the contact elements 12 and the electrical insulation 20 are inserted in the heating element housing 11, and then the respective heating element housing is pressed in the central region so that a favorable thermal contact between the elements of the heating element and the heating element housing 11 can be achieved.

The fluid to be heated can flow past the heating element housing on both sides, in the direction of the flow, so that a favorable flow guidance can be achieved. In FIG. 4, it can be seen that the tubes of the heating element housing are closed on the base side. This can be done by folding or by crimping or by placing a termination element 21, or by welding, soldering or adhesive bonding.

In FIG. 4, it can be seen that the openings 10 are formed in the base 6 as passages with a raised edge. Here, the raised edge 23 may extend into the interior 13 of the housing 2 or, as shown, face away from the interior space 13.

FIG. 5 shows an alternative electric heating device 1, in which the heating elements 9 are formed as a rather flat elements, wherein the heating element housing 11 is preferably formed from shells, in particular half shells 52, 53, so that the elements of the heating elements 9, that is, the heater 19, the contact elements 12 and the electrical insulation 20 can be inserted in the shells or half shells 52, 53, and can be adhesively bonded, for example, wherein the two half shells 52, 53 of the heating element housing 11 are, for example, thermally joined at the edge 22, as in particular welded, soldered or adhesively bonded.

The construction of the heating elements 9 is rather flat with a two-dimensional design which approximately shows a rectangular contour, which almost fills the interior 13 of the housing 2 in the longitudinal direction. The heating elements 9 form a kind of partition that causes a meandering flow through the housing 2. It can be seen in FIG. 5, that the central heating element 9 bears against a rear wall of the housing 2, which is away from the fluid inlet 3 and the fluid outlet 4. By way of example, the two outer heating elements 9 can bear on the wall of the housing 2, in which the fluid inlet 3 and the fluid outlet 4 are arranged.

It can be seen in FIG. 5, that the peripheral edge 22 of the heating element 9 almost completely wraps around, except for the passage 14 which is formed as an oval opening in order to guide the contact elements 12 out of the heating element 9. The configuration of the passage 14 may also be different and need not necessarily be oval. The passages 14 of the adjacent heating elements 9 are arranged offset from one another. Thus, the passageway 14 may be designed such that the heating elements 9 approach each other relatively closely, transverse to the flow direction of the fluid.

FIGS. 4 and 5 show that an arrangement of heating elements 9 in an adjacent arrangement can be formed relative to each other. Basically, the heating elements 9 may be arranged in columns, longitudinally and/or transverse to each other, i.e., in the flow direction of the fluid or transverse thereto.

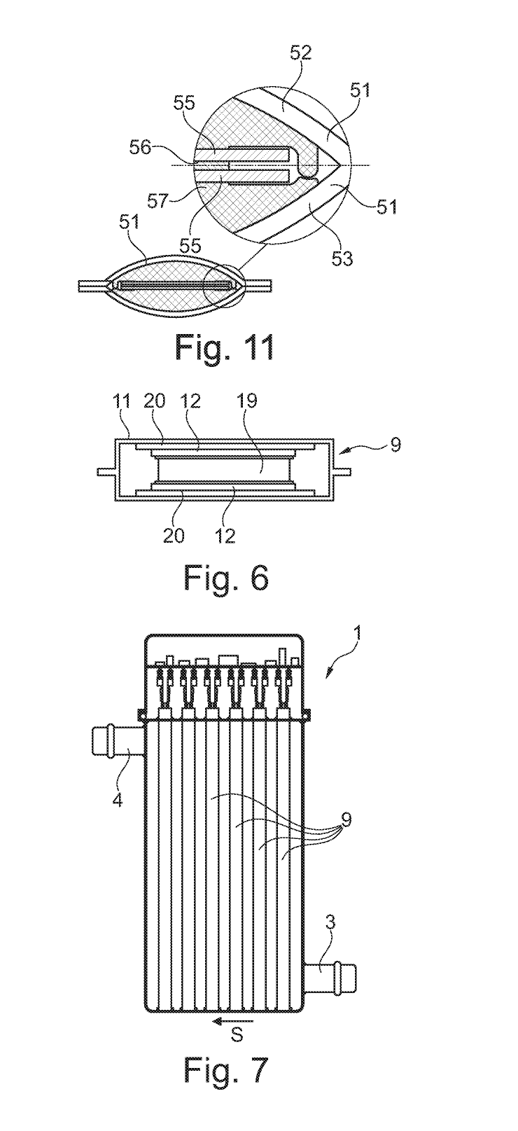

FIG. 6 schematically shows the arrangement of the elements of the heating elements 9, wherein the heater 19 and the contact elements 12 and the electrical insulation 20 are arranged in the peripherally closed heating element housing 11. In the embodiment of FIG. 6, the electrical insulation 20 is formed by two insulating elements. It may also be formed by a single, for example, tubular element. In the embodiment of FIG. 6, the heating element housing 11 is rectangular in section. This can also be configured otherwise, such as round, oval, square, etc.

FIG. 7 shows an embodiment of an electric heating device 1 similar to FIG. 2, wherein the heating elements 9 in FIG. 7 are arranged transverse to the flow direction S between the fluid inlet 3 and the fluid outlet 4, while in FIG. 1, they are disposed longitudinally to the flow direction S between the fluid inlet 3 and the fluid outlet 4. This means that the flow of the fluid to be heated between the fluid inlet 3 and the fluid outlet 4 in FIG. 2 preferably runs in a direction parallel to a plane between the fluid inlet and fluid outlet, wherein the flow passes substantially parallel to the heating devices.

In the embodiment of FIG. 7, the heating elements 9 are substantially disposed transverse to the flow direction S between the fluid inlet 3 and the fluid outlet 4, so that fluid flows substantially perpendicular to a plane between the fluid inlet and the fluid outlet, that is, between the heating elements 9, wherein the fluid is thereby deflected at least twice in order to be deflected starting from the fluid inlet 3, then to transversely flow between the heating elements 9 to subsequently be deflected again towards the fluid outlet 4.

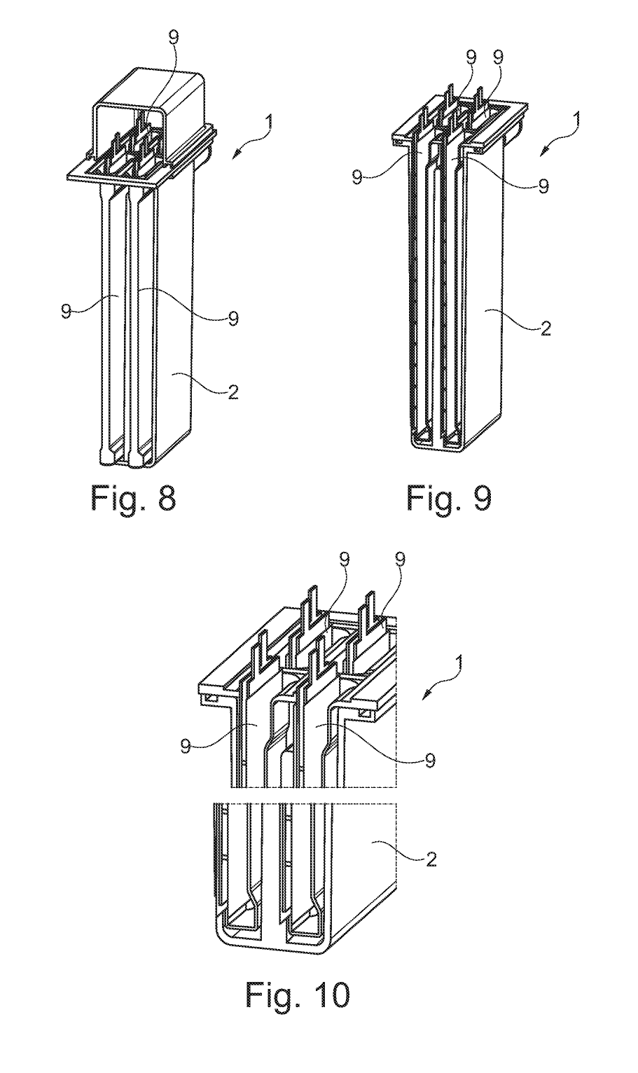

FIGS. 8 to 10 show an embodiment in which the heating elements 9 are arranged one after the other when viewed in two rows transverse to the flow direction and when arranged in at least two columns in the flow direction, so that a total of at least four or more heating elements 9 are arranged. The heating elements 9 are disposed within the housing 2, that is in two rows, wherein at least two or more heating elements 9 may be arranged in a row. For example, according to FIG. 2, a plurality of heating elements 9 may also be arranged in a row one after the other.

FIGS. 11 to 13 show details of heating element housings 11 according to FIG. 3. The heating element housings 11 are correspondingly formed from two shells 52, 53, wherein in accordance with FIG. 11, the electrical insulation 20 is formed as a molded part, which almost completely encloses the contact elements 55 and the heater 56, wherein preferably a molded part or two molded parts may be provided as electrical insulation 20.

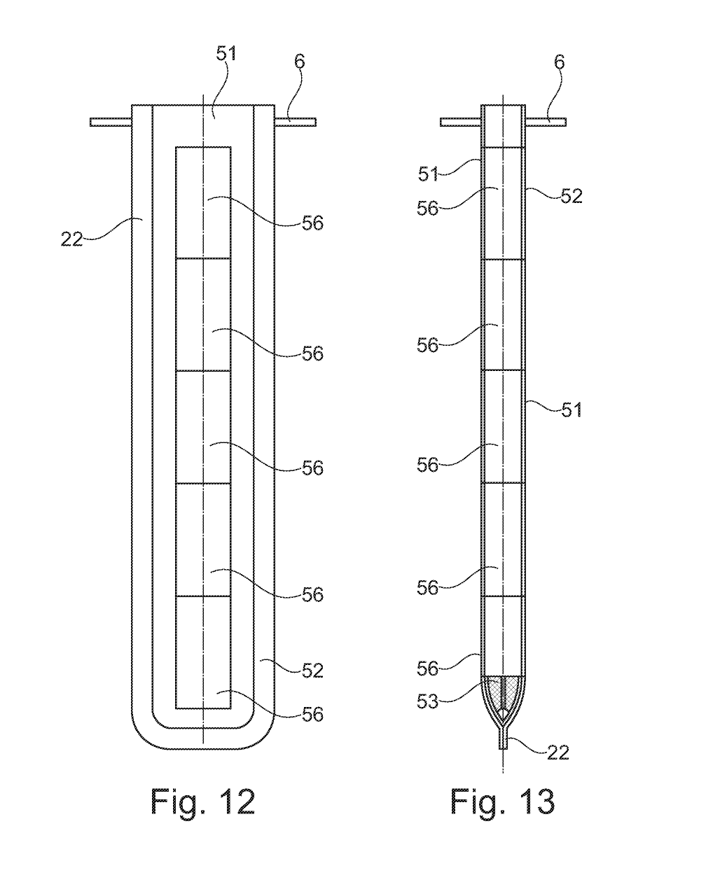

In FIGS. 12 and 13, it can be seen that the half shells 52, 53 have an abutting edge 22, which is used to connect the half shells 52, 53, for example by soldering, welding and/or adhesive bonding. The half shells 52, 53 are also connected to the base 6 by means of thermal joining, for example by soldering, welding and/or adhesive bonding.

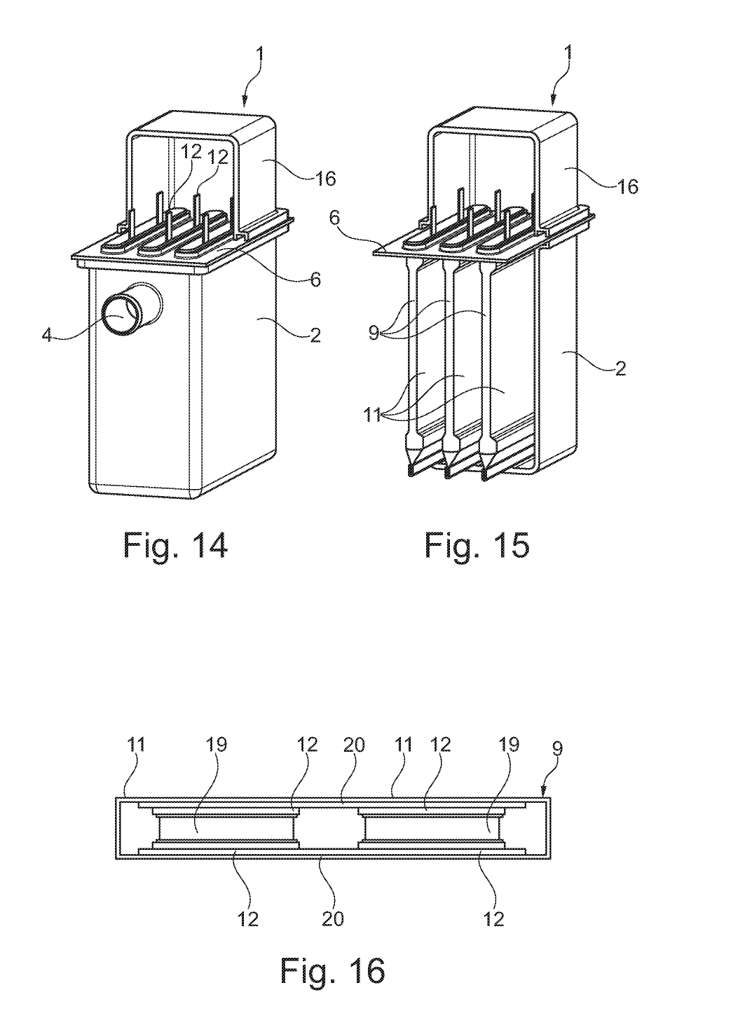

FIGS. 14 to 16 show a further embodiment of an electric heating device 1, in which a plurality of rows of heater 19 are arranged in the longitudinal direction of the heating element housing 11, wherein the heater 19 electrically contact each other via contact elements 12. The contact elements 12 can be provided for a row of heater 19, wherein the electrical insulation 20 electrically insulates the respective contact elements 12 from the heating element housing 11. In this case, a few larger heating elements 9 are preferably provided which are arranged, for example, in one to three tiers.

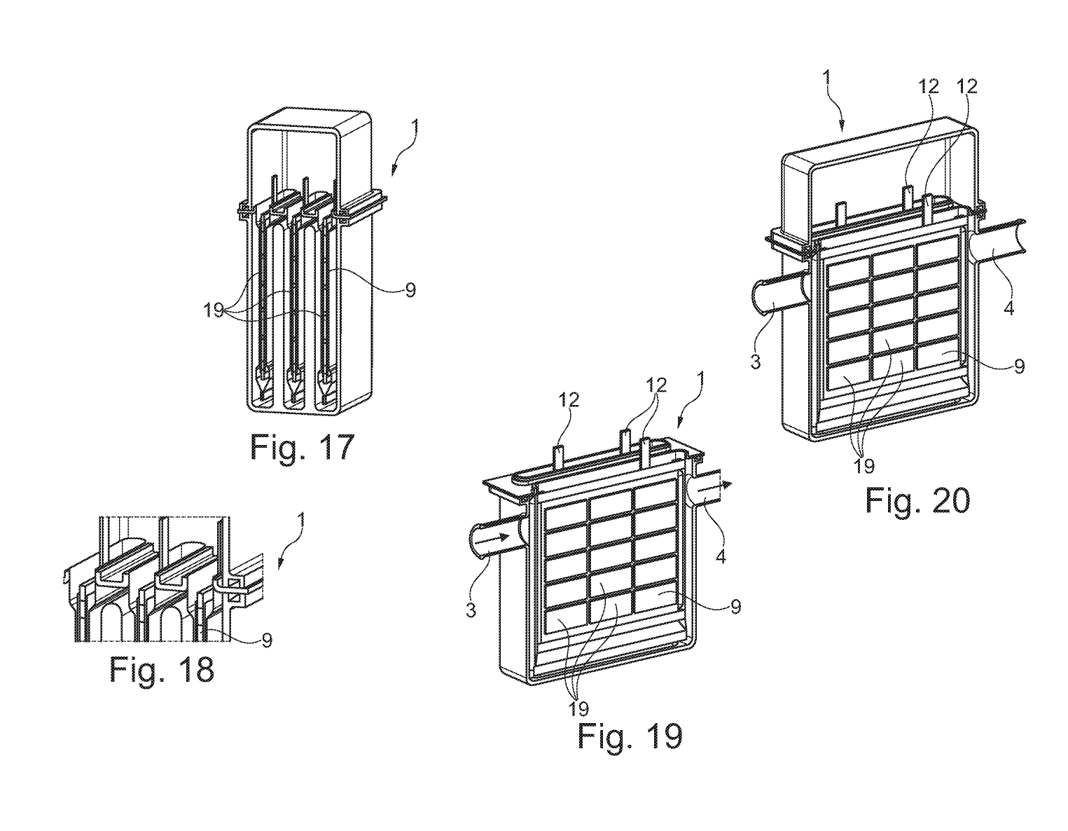

FIGS. 17 to 19 show corresponding views of heating devices 1, in which heating elements 9 with a plurality of heater 19 are provided. FIGS. 19 and 20 show that three columns, for example, are arranged with five rows of heater 19 within a heating element 9. These may, for example, be contacted column by column or entirely by single or flat contact elements 12, so that for example, only 1, 2 or 3 or a small number of such flat heating elements are arranged adjacent to each other, in particular between fluid inlet 3 and fluid outlet 4. In order for the heater 19 to be geometrically arranged in such a way, auxiliary frames can be provided, which position the heater 19 in the heating element housing 11. Other geometric configurations of heater in the heating element housing are also possible. Such geometric configurations allow for the two-dimensional uniform distribution of the heater 19 in the heating element housing 11, resulting in a uniform heating of the heating element housing 11, in particular in regard to broader, more two-dimensional heating elements.

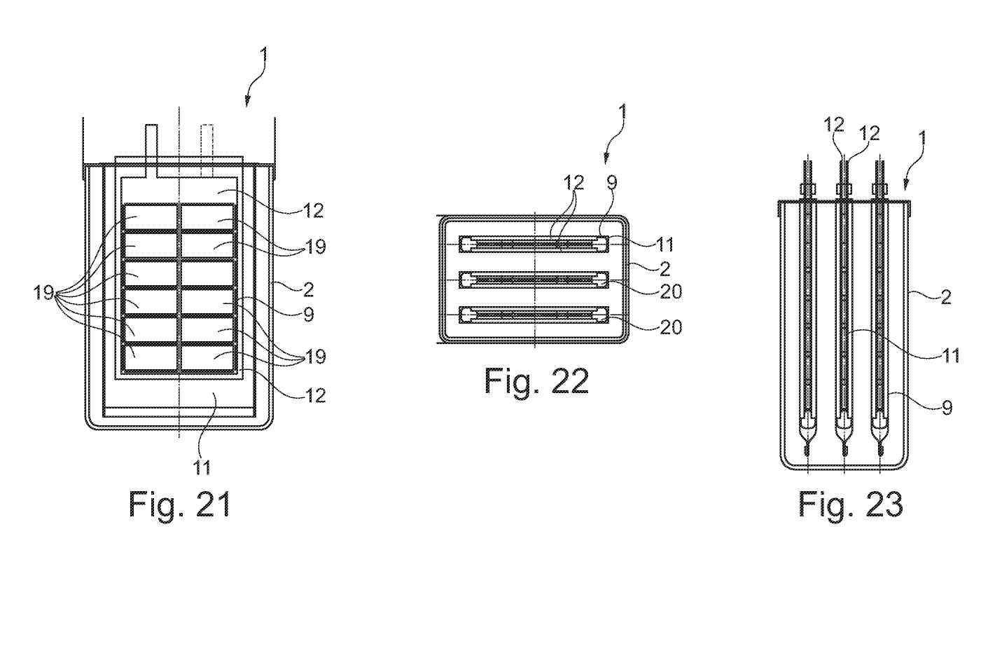

FIGS. 21 to 23 show alternative heating devices 1, in which three heating elements are arranged adjacent to each other, wherein two columns with six rows of heater 19 are arranged in each heating element. In this case, the heater 19 of a heating element 9 are contacted by two-dimensional contact elements 12 in each case on one side, so that the heating elements can each be controlled as a whole.

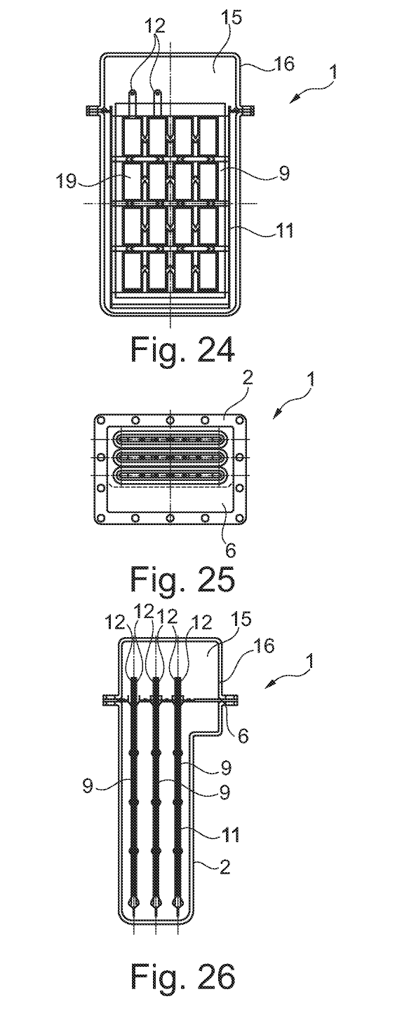

FIGS. 24 to 26 show an electric heating device 1 with an electronic control unit 15, which contacts the contact elements 12 for controlling the heater 19 for heating a fluid flowing through. The heater 19 are thereby arranged in rows and columns within a heating element 9, wherein three heating elements 9 are arranged side by side, adjacent to each other. Depending on the arrangement and configuration of the contact elements 12 and the heater 19, the respective heating element 9 as a whole can be switched on or off or controlled in the heat release, or different groups of heater 19 may be connected to one another within a heating element 9 to achieve improved control within a respective heating element 9. In this way, each column of heater 19 may, for example, be controlled individually.

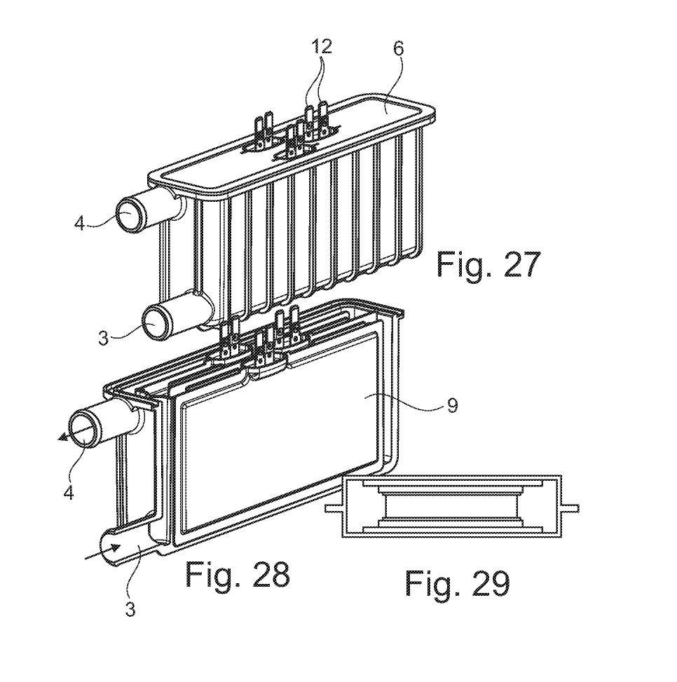

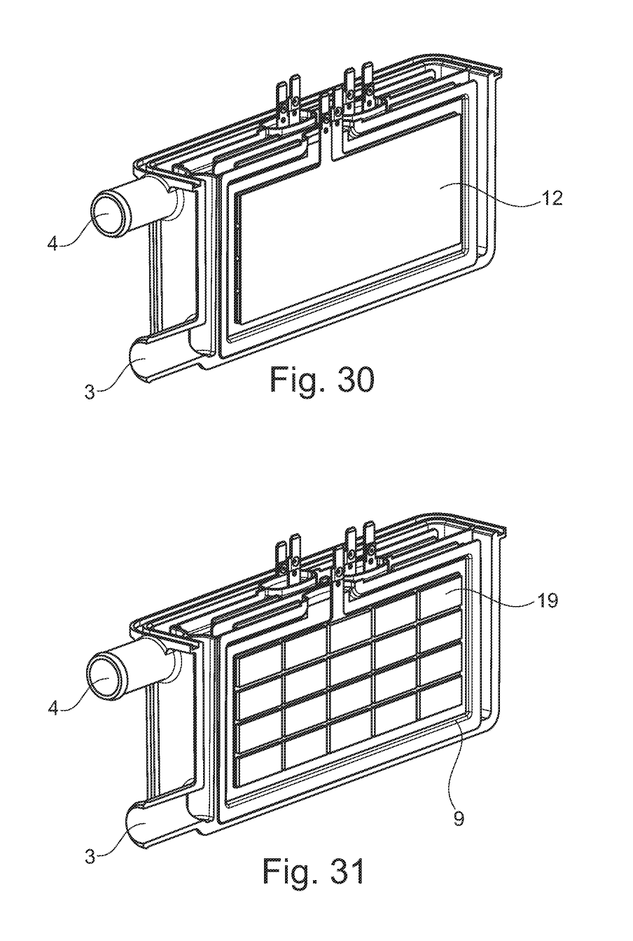

FIGS. 27 to 31 show embodiments according to FIG. 5, wherein the heater 19 are arranged in rows and columns according to FIG. 31, wherein the contact elements 12 are flat elements according to FIG. 30, which contact all the heater 19 of a heating element 9. Accordingly, the heater 19 of a heating element 9 can be controlled together via the control of the two opposing contact elements 12. Arranging three such heating elements 9, a corresponding control of the electric heating device can be achieved.

According to the invention, it is particularly advantageous when the heating device and/or the heating elements is or are sealed self-contained or are encapsulated. In this case, a thermal joining method of the heating device and/or the heating elements can be used.

The heater can be designed as PTC elements. Alternatively, elements without PTC effect can be used.

The heater are preferably energized via two contact elements as contact electrodes. Thus, the heater are arranged between two contact elements, such as contact electrodes.

Instead of the heater 19, which are arranged between two plate-like contact elements, for example, a heater could also be used, for example as a thermal ceramic, which is provided with an applied and/or printed resistance path, or resistance paths. This resistance path would then be connected electrically to achieve a current flow. The resistance path would act as a contact element. In that case, no sheet-like contact elements would be used, but rather a support material, for example, of insulating ceramic and/or alumina with good thermal conductivity, would be provided with applied resistance paths as contact elements and contacted. If necessary, the current would then not flow via the short distance from contact element to contact element, but instead would flow the long distance along the length of the applied resistance path.

The heater is preferably suitable for high voltage applications.

As an alternative to the design of the heating element housing 11 using two half shells 52, 53, a trough with a substantially flat cover may also be provided.

The electrical contacting of the heating elements is generally perpendicular to the flow direction of the fluid to be heated.

As electrical insulation, a solid or flexible material or element can be used, such as a form element or a film.

In the housing 2, an arrangement of turbulators for increasing performance is also possible between the heating elements 9 and/or between the heating elements and the housing 2.

In an advantageous embodiment, the base 6 for the reception and arrangement of the heating elements also serves to directly contact the control unit to a power electronics. The base 6 is used to seal off the housing 2.

The base 6 serves to secure and seal the control unit or the power electronics and to seal the housing 2 that is flowed through by the fluid.

The nominal electric power of the heating device 1 may be in the range of 3 kW to about 9 kW, preferably at about 5 kW.

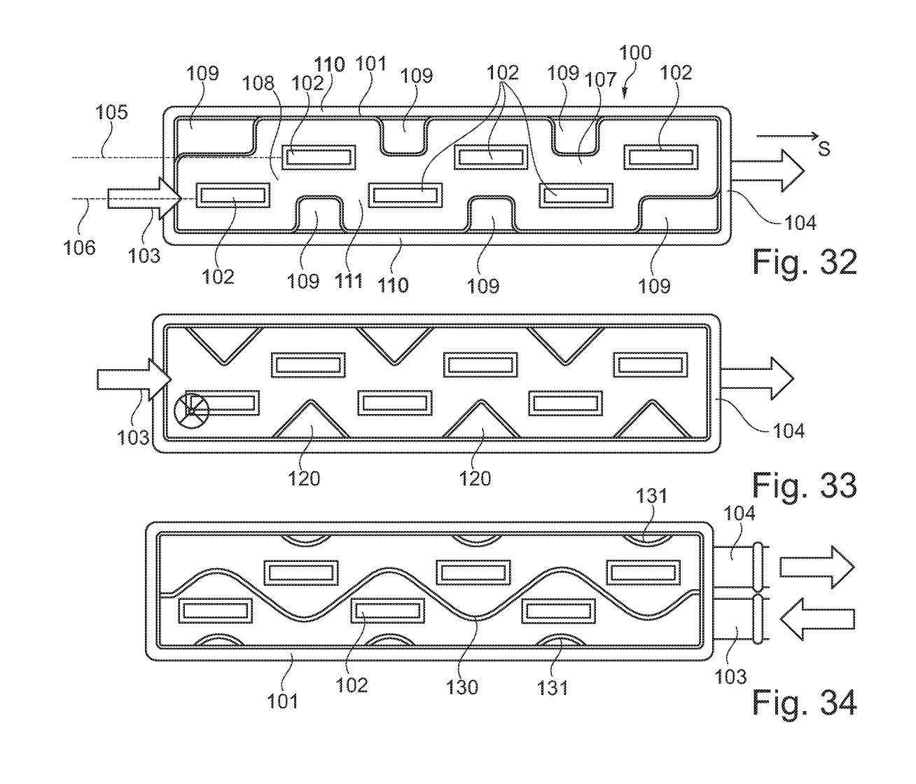

FIG. 32 shows a view of a cross section through an inventive heating device 100. The heating device comprises heating elements 102 arranged in a housing 101. The housing includes a fluid inlet 103 and a fluid outlet 104 so that a fluid can flow into the housing of the heating device 100 at the fluid inlet 103, said fluid flows through the housing 101. Subsequently, the fluid flows back out of the housing 101 at the fluid outlet 104.

The heating elements 102 are arranged in the housing 101 in two rows 105, 106, wherein the rows 105, 106 are arranged laterally offset from one another. When viewed in the flow direction S of the fluid, the heating elements 102 of the rows 105, 106 are arranged offset from each other, so that in each case every second heating element 102 is arranged in row 105 or in row 106.

The electric heating device 100 comprising the housing 101, the fluid inlet 103 and the fluid outlet 104, is constructed such that the housing 101 can be flowed through by the fluid. In this case, a number of heating elements 102 project into the interior 107 of the housing 101.

The heating elements 102 in this case have a heating element housing, wherein a heating element 102 in the heating element housing comprises at least one heater, and contact elements contacting the at least one heater, and an electrical insulation for insulating the contact elements from the heating element housing.

The contact elements also project out of the heating element.

As with the previously described embodiments, the heating elements 102 are sealingly connected to the housing 101 with their heating element housing.

The heating elements 102 are arranged such that they are flowed around by the fluid on both sides, in the flow direction S of the fluid from the fluid inlet 103 to the fluid outlet 104.

The heating elements 102 are arranged one after the other and laterally offset to each when viewed in the flow direction of the fluid.

Between successive heating elements 102, a spacing 108 in each case is arranged or formed, so that the fluid can also flow between the heating elements, transversely to the flow direction S, and a fluid exchange can take place.

FIG. 32 also shows that flow guidance elements 109, which influence the flow of the fluid, project from the housing 101 into the interior 107 of the housing 101. The flow guidance elements 109 are arranged approximately at the height of the heating elements 102 and are adjacent to these, wherein said flow guidance elements are arranged alternately on the one, or on the opposite, side wall 110 of the housing 101.

Thereby, the fluid path 111 of the fluid is narrowed locally, so that on both sides at the height of the heating elements 102, the fluid has access to the approximately same cross section, and the fluid is thus directed to the heating element 102 and can flow past the latter.

In the embodiment of FIG. 32, the flow guidance units 109 are formed as rectangular structures that are formed for example as sheets or shell elements and are connected to the side walls 110. In the corner regions of the housing, corresponding, approximately rectangular, flow guidance units 109 are formed.

It can be seen that the fluid path 111 is formed approximately meandering or serpentine.

In the embodiment of FIG. 33, the flow guidance elements 120 are formed triangular.

It can be seen in FIGS. 32 and 33, that the flow through the housing 101 takes place in one pass, i.e., as I-flow.

FIG. 34 shows a further embodiment in which, as compared to FIGS. 32 and 33, an s-shaped partition is centrally arranged, which meanders along between the heating elements 102 so that flow through the housing 101 results in a deflection, that is, a U-flow exists. The fluid flows from the fluid inlet 103 through the first half of the housing 101, is then diverted, and then flows back to the fluid outlet 104.

In the embodiment of FIG. 34, the flow guidance units 131 are arcuate.

In the embodiments of FIGS. 32 to 34, a flow guidance element 109, 120, 131 is disposed in each case adjacent to a heating element 102 and reduces the flow cross section for the fluid adjacent to the heating element 102.

It can also be seen in FIGS. 32 to 34, that the heating elements have an extension in the flow direction, which is greater than an extension transverse to the flow direction, as viewed in a plane parallel to the wall with the openings, in which the heating elements are inserted. This plane of the wall is thus virtually parallel to the sectional plane shown. The heating elements are thus elongated in the flow direction S, or oriented in the flow direction S, and thus longer than transverse to the flow direction S.

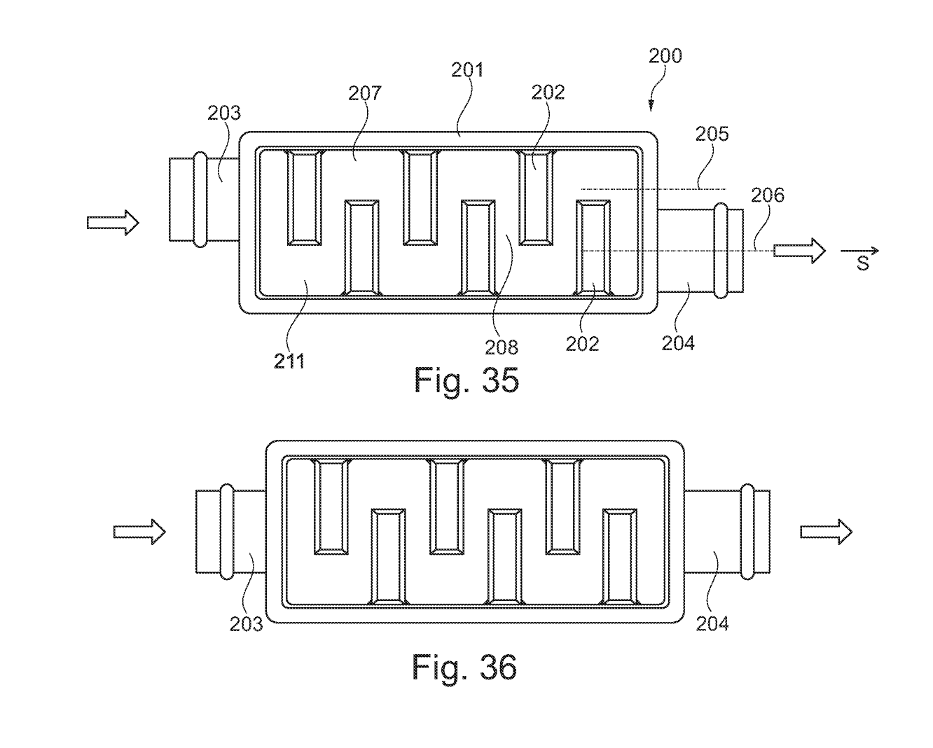

FIG. 35 shows a view of a section through an inventive electric heating device 200. The heating device comprises heating elements 202 arranged in a housing 201. The housing 201 has a fluid inlet 203 and a fluid outlet 204 so that a fluid can flow into the housing 201 of the heating device 200 at the fluid inlet 203, said fluid flowing through the housing 201. Subsequently, the fluid flows back out of the housing 201 at the fluid outlet 204. The fluid inlet 203 and fluid outlet 204 are disposed on opposite sides of the housing and laterally offset from one another.

The heating elements 202 are disposed in the housing 201 in two rows 205, 206, with the rows 205, 206 being laterally offset from one another. When viewed in the flow direction S of the fluid, the heating elements 202 of rows 205, 206 are offset from each other so that in each case every second heating element 202 is arranged in row 205 or in row 206.

The electric heating device 200 comprising the housing 201 with the fluid inlet 203 and the fluid outlet 204 is constructed such that the housing 201 can be flowed through by the fluid. In this case, a number of heating elements 202 project into the interior 207 of the housing 201, as already described above.

The heating elements 202 in this case have a heating element housing, wherein a heating element 202 has at least one heater in the heating element housing, and the at least one heater has contacting contact elements and an electrical insulation for insulating the contact elements. The contact elements also protrude from the heating element. As with the previously described embodiments, the heating elements 202 are sealingly connected to the housing 201 with their heating element housing.

The heating elements 202 are arranged such that they can be flowed around by the fluid only on one side, in the flow direction S of the fluid, from the fluid inlet 203 to the fluid outlet 204. This means that the heating elements abut a side wall 209 of the housing 201 and are only flowed around at the non-contacting side of the heating element 202.

The heating elements 202 are arranged one after the other and laterally offset as viewed in the flow direction S of the fluid.

Between successive heating elements 202, in each case a spacing 208 is arranged or formed, so that the fluid can flow between the heating elements 202, also transverse to the flow direction S, thus resulting in a zig-zag-shaped fluid path 211.

It can be seen that the fluid path 211 is formed approximately as a serpentine.

In the embodiment of FIG. 36, the fluid inlet 203 and the fluid outlet are aligned in a row and are not laterally offset from one another.

FIGS. 35 and 36 also show that the heating elements 202 respectively abut one side wall 209 of the housing 201 or are attached thereto. In particular, the respective heating elements 202 are disposed bearing on opposite side walls 209 of the housing, in particular alternating, or are attached thereto. This is preferably done by thermal joining, such as welding, soldering or adhesive bonding.

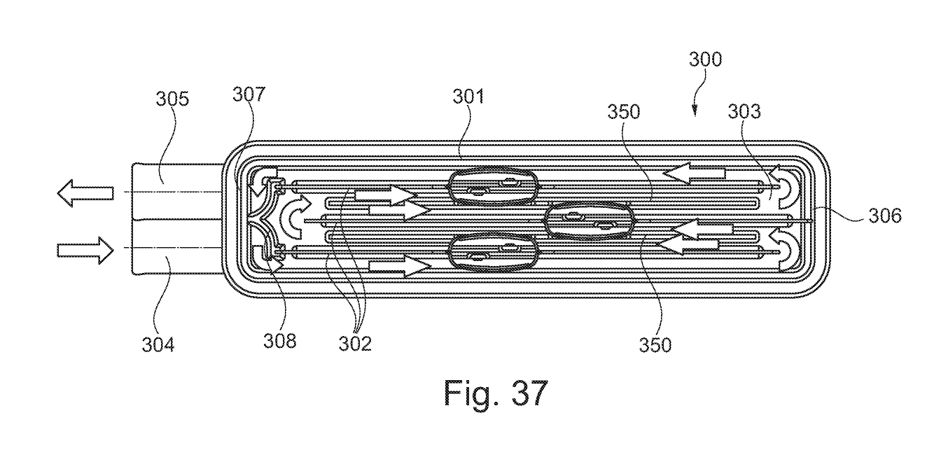

FIG. 37 shows a further embodiment of an electric heating device 300, in which three heating elements 302 are arranged in the housing 301. The heating elements 302 are configured two-dimensionally and extend in the flow direction S, approximately over the entire length of the interior 303 of the housing 301. Three heating elements 302 are disposed. The middle heating element 302 is disposed on the side wall 306 located opposite the fluid inlet 304 and the fluid outlet 305, and is sealed. The two outer heating elements 302 are hinged opposite the side wall 307 with the fluid inlet 304 and the fluid outlet 305 by means of a fluid wall element 308, and are sealed. The result is a meandering fluid path from the fluid inlet 304 towards the fluid outlet 305.

The heating elements 302 are configured two-dimensionally and assume almost the entire cross section of the interior 303 of the housing 301 in their plane, and form a flow guidance element themselves.

It is also advantageous if at least one partition is arranged in the interior of the housing, which divides the interior of the housing into a plurality of fluid paths, which are flowed through in series by the fluid.

It is also advantageous if the heating elements are arranged such in the interior of the housing, that they divide the interior of the housing into a plurality of fluid paths, which are flowed through in series by the fluid.

It is also expedient if the heating elements are arranged such that at least individual heating elements are arranged in at least one of the fluid paths, or that at least individual heating elements are arranged in each of the fluid paths, or the fluid paths are guided past at least one of the heating elements.

Grooves are advantageously recessed in the housing. In these grooves, the edge of the half shells of a heating element is arranged and fastened. This results in a directed flow of the fluid to be heated.

Thus, in three heating devices, the flow can be divided into four fluid paths. Housing partitions 350 serve to guide the flow and increase the flow rate and improve performance.

As an alternative to the housing partitions 350 or in addition to these, additional measures for improved flow turbulence and thus increased performance can be incorporated, such as knobs, ribs or turbulence inserts.

According to FIG. 37, this results in a four pass design. The fluid is deflected by 180° threefold. The fluid flows around each heating element 302 on the two sides facing the fluid, in different directions.

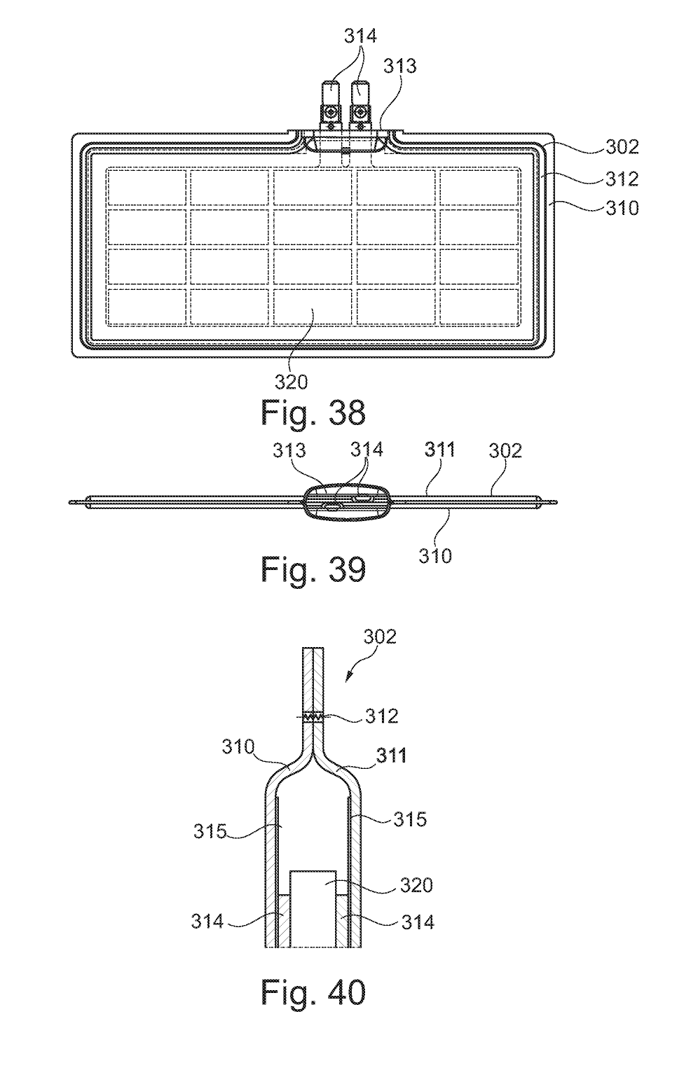

FIGS. 38 to 40 show a heating element 302 or details thereof in respect of how it is used in the embodiment of FIG. 37.

FIG. 38 shows a side view of a heating element 302 having two half shells 310, 311, which are welded together. Alternatively, the half shells 310, 311 can also be soldered or adhesively bonded. In FIGS. 38 and 40, the weld seam 312 can be seen, which is arranged almost circumferentially. In this case, the weld seam 312 omits the passage 313 for passing through the contact elements 314, wherein the passage 313 may be closed by an insert or by a sealing compound.

In its interior, the heating element 302 has an arrangement of heater 320, which are contacted by the contact elements 314 and are insulated by an electrical insulation 315. The electrical insulation can be formed as a foil 315, as a molded part or as a sealing compound, etc. Alternatively, the inside of the half shell can also be coated with an electrically insulating material. Alternatively, the contact elements or the contact plates/contact electrodes can be coated on the outside with an electrically insulating material.

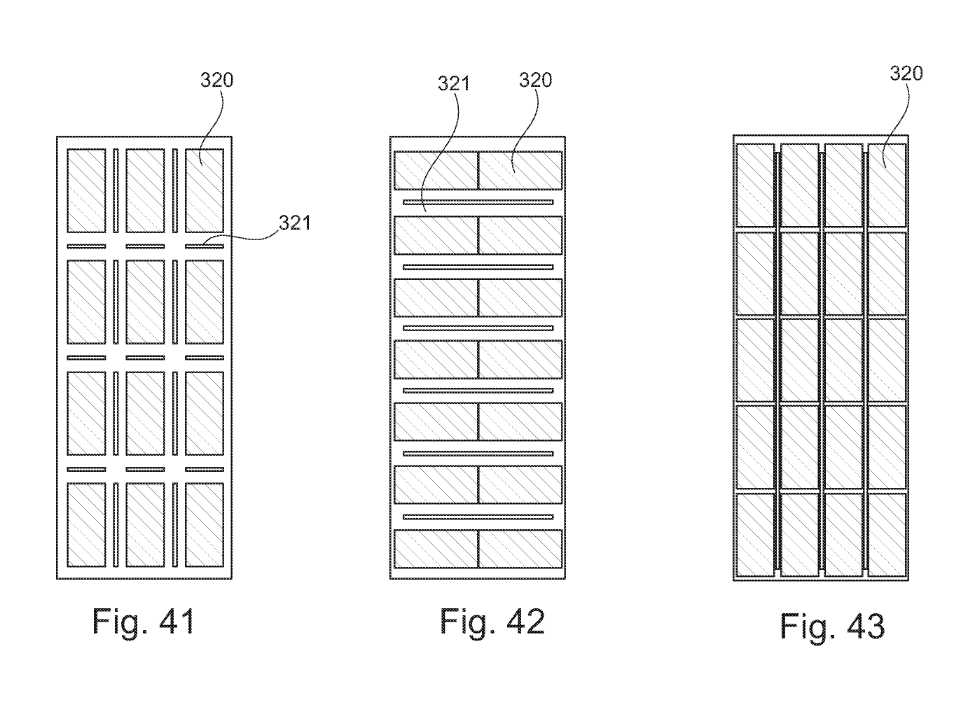

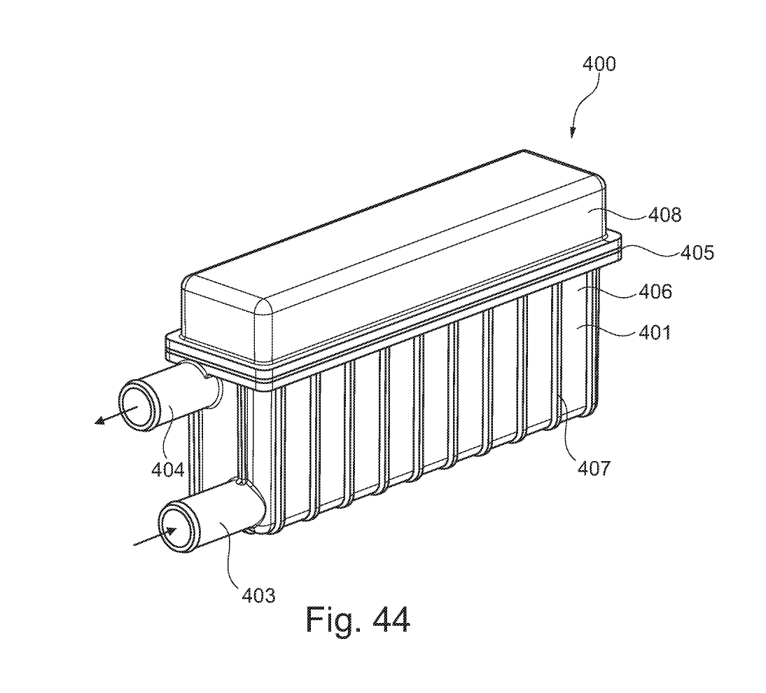

FIGS. 38 and 41 through 43 disclose various arrangements of heater 320 of a heating element 302. The heater 320 are, for example, designed as PTC elements. The heater 320 are arranged in rows and columns. According to FIGS. 38 and 43, four times five heating elements 320 are arranged. In FIGS. 41 and 42, the heater 320 are arranged in arrays of three times four or two times seven, wherein in FIG. 41, a separator 321 for separating, and arrangements of the respective heater, are provided. For this purpose, the separator is provided between respective, adjacent heater 320. In FIG. 42, the heater are arranged in two rows, that is, always two heater adjacent to each other in a row, wherein such rows of two heater are separated from one another by the separator.

According to the invention, when viewed in a flow direction of the fluid, the heating elements may be laterally arranged side by side in rows so that the fluid can flow between the rows. The heating elements in a row or in several rows can be located adjacent to one another and preferably side by side, in the flow direction, one after the other. Also, the heating elements of a row may be arranged one after the other in the flow direction and at a distance from each other.

The flow guidance in the housing can be single pass, without deflection, two pass, that is, with deflection, or three pass or four pass or even multi-pass. The one-, two- or multi-pass flow-through on the fluid side generally takes place on one plane, but could also take place in a second plane. That is, the deflection of the fluid occurs in a third plane.

The heating elements may be arranged along, or transverse to, the fluid flow guide. Advantageously, fluid circulates both sides of each heating element. Alternatively, the fluid can flow past only one side.

FIGS. 38 to 43 show arrangements of heater. Alternatively, the heater may be spaced at different intervals. By spacing the heater at greater intervals, thermal influence of the heater relative to one another can be reduced. The greater intervals of the heater to one another prevents the heater from thermally influencing each other and possibly limiting performance when PTC elements are used.

FIG. 44 shows a view of a heating device 400 from the outside. The heating device 400 comprises a housing 401 with a fluid inlet 403 and a fluid outlet 404. The fluid inlet 403 and fluid outlet 404 are disposed on the same side of the housing 401. This can also be configured otherwise such that, for example, the fluid inlet 403 is disposed opposite the fluid outlet 404.

The housing 401 has a base 405 and a lower housing part 406, which are connected and which close off an interior space. Heating elements, not shown, are connected to the base 405, which protrude into the interior of the housing 401 so as to heat a fluid flowing through the housing 401. Externally, the housing part 406 has ribs 407, which are arranged around the housing 401, circumferentially in the vertical direction. These ribs 407 preferably increase stability, in particular against increased internal pressure. The housing part 406 may, for example, be made of plastic or metal, such as aluminum or steel.

On the base 405, a further housing part 408 is arranged, which is preferably connected to the base 405. This further upper housing part 408 may be configured as a control unit housing for receiving a control unit for controlling the heating device 400.

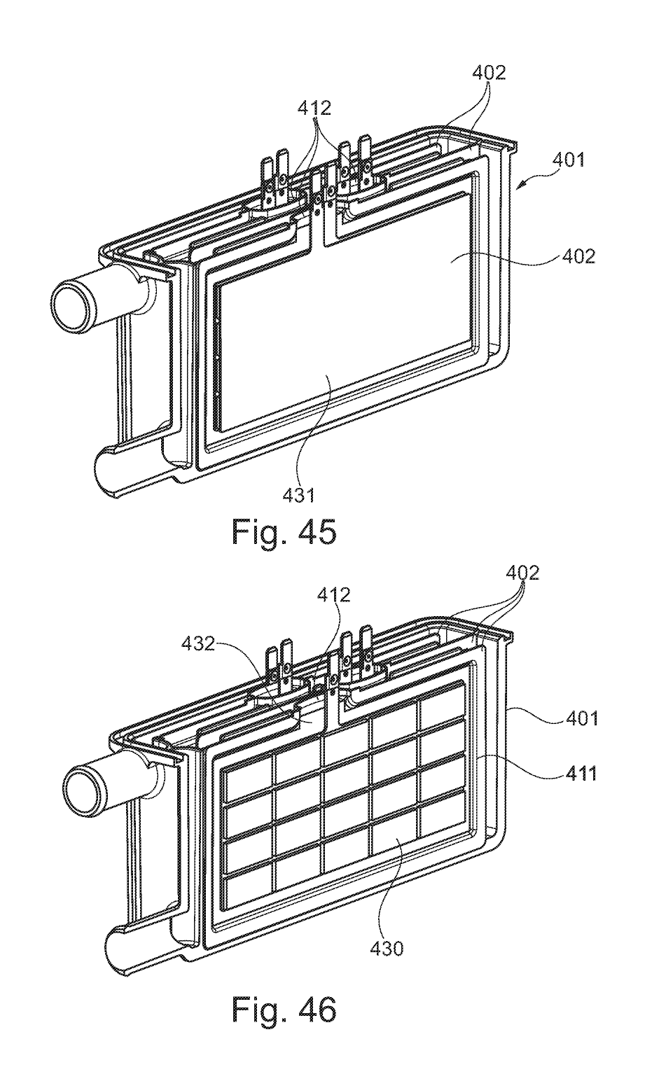

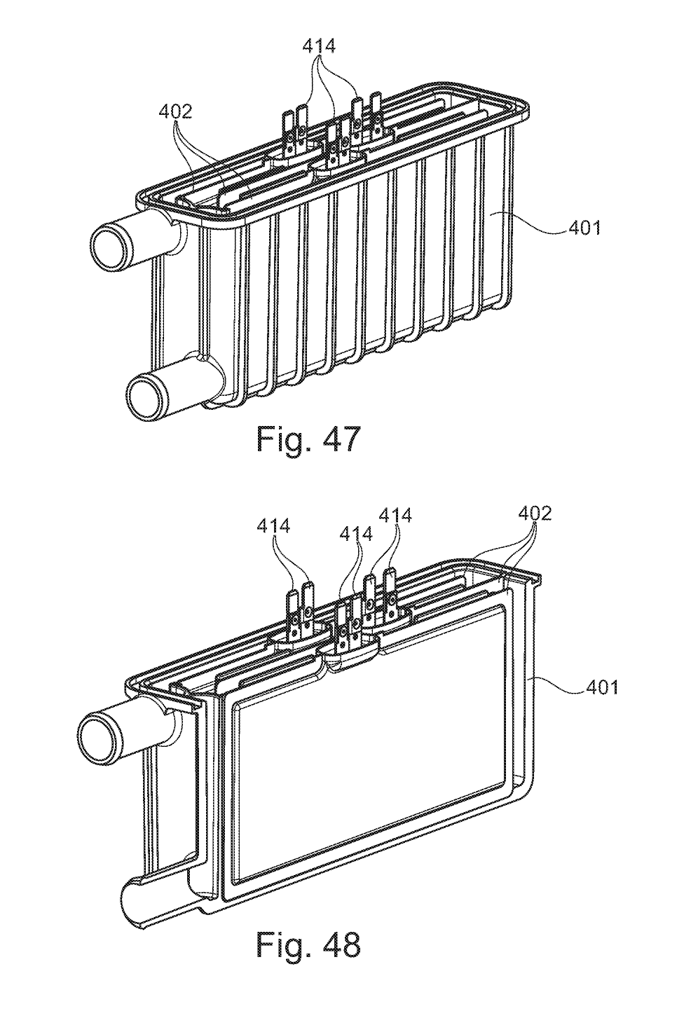

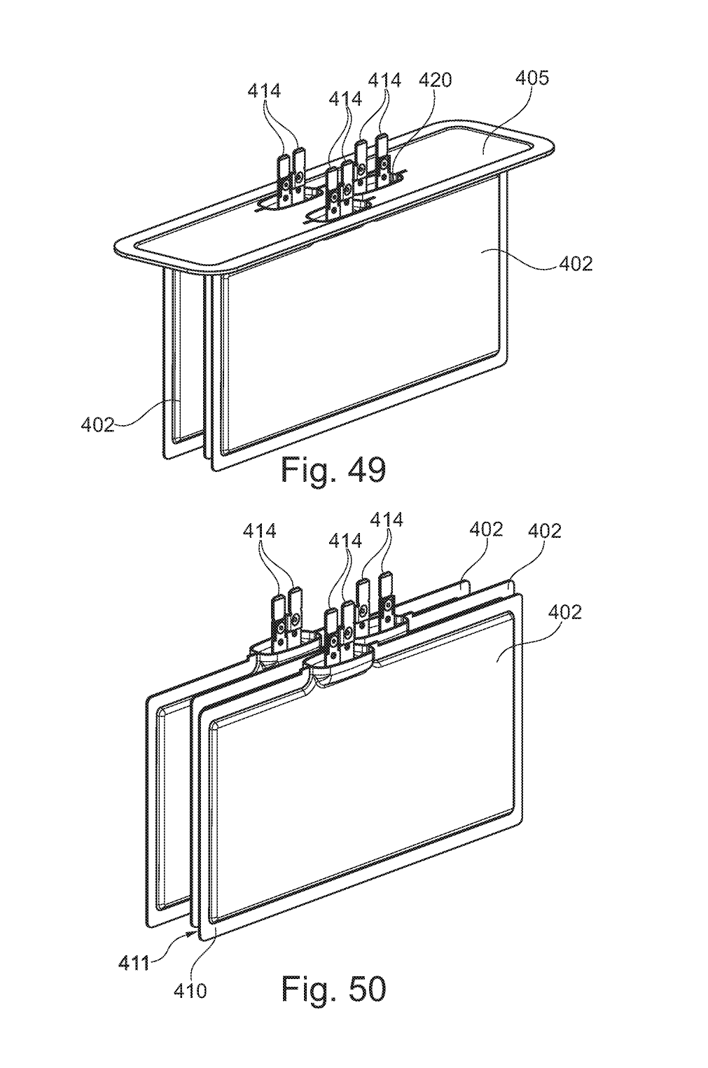

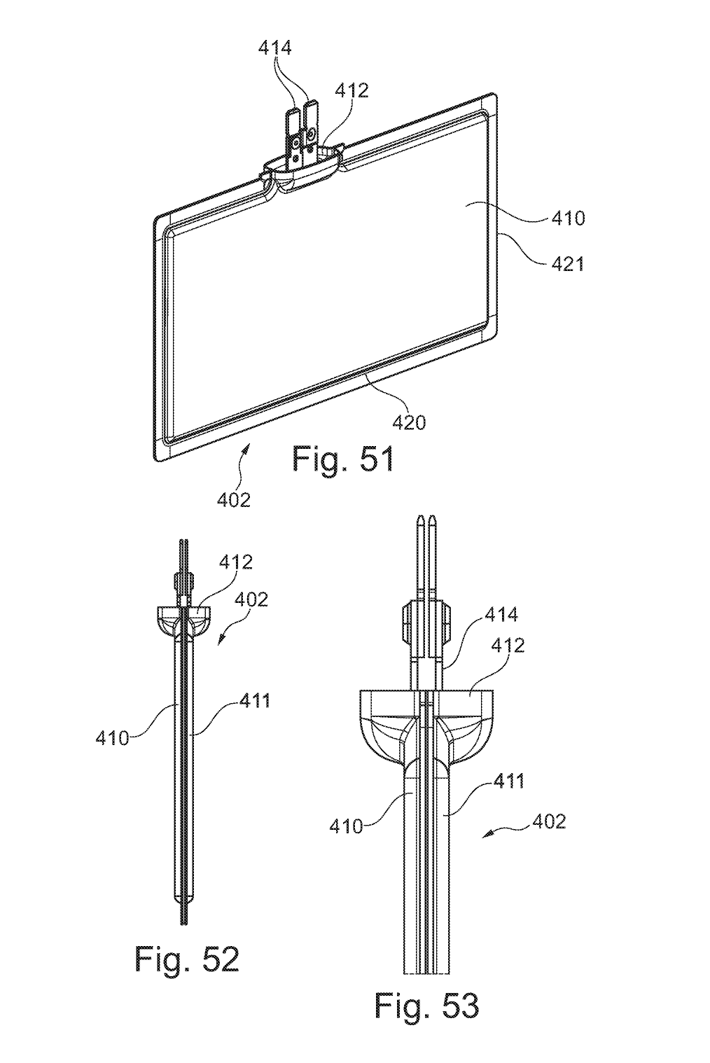

FIGS. 45 to 50 show details of an arrangement of three heating elements 402 in the housing 401 of the heating device 400. The heating elements 402 are configured two-dimensionally, as has already been shown, for example, in FIGS. 38, 39. A heating device thereby has two half shells 410, 411, see also FIGS. 51 to 53. These half shells 410, 411 are joined together by thermal joining and, except for the passage 412, are connected to each other in a fluid-tight manner. In the area of the passage 412 which forms an oval bulge of the half shells 410, 411, the contact elements 414 protrude from the heating element 402. The half shells 410, 411 are thermally joined to one another and are inserted into an opening 420 of the base 405, where they are also fluid-tightly joined to the base, for example by thermal joining, such as welding, soldering or adhesive bonding.

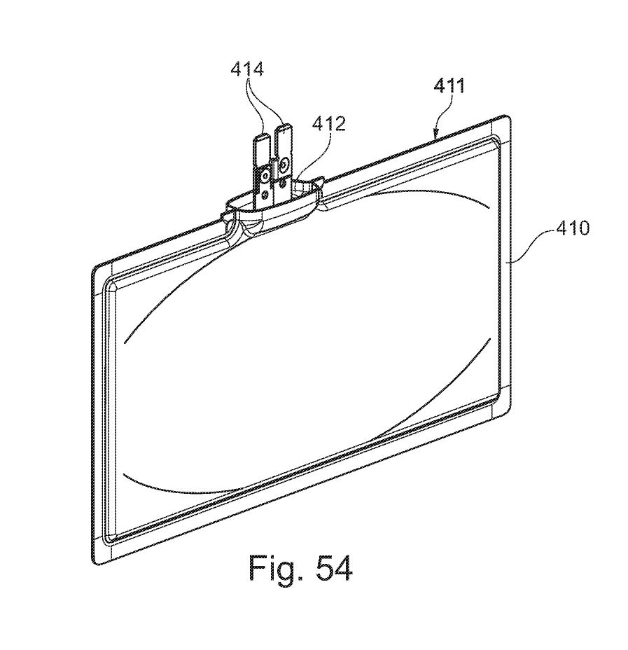

FIG. 54 shows a heating element 402 with the half shells 410, 411 prior to thermal joining; FIG. 51 shows the heating element 402 after thermal joining with the nearly complete, circumferential weld seam 480. The weld seam runs on an edge portion 421 of the respective half shell, said half shells bearing against one another.

In this embodiment, three heating elements 402 are arranged parallel to one another and are offset to one another in the longitudinal direction.

It is preferred that the half shells 410, 411 are slightly bulged in order to accommodate the heater 430, the contact elements 431 and the electrical insulation 432.

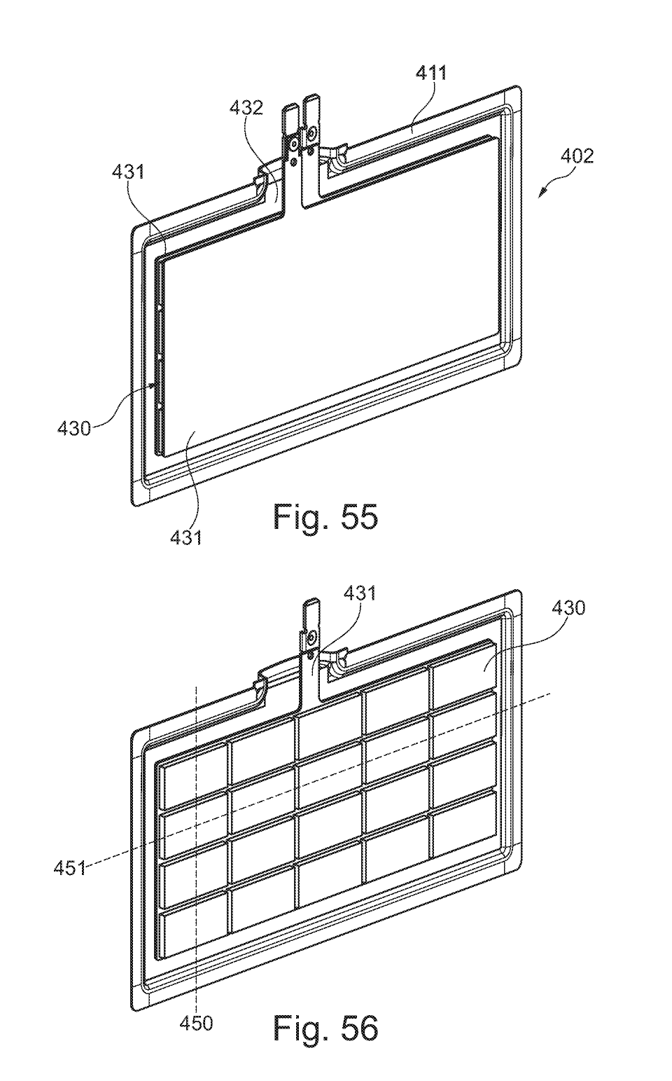

FIGS. 55, 59 and 60 show the arrangement of the unit of heater 430, contact elements 431, which are stacked and arranged in a heating element 402.

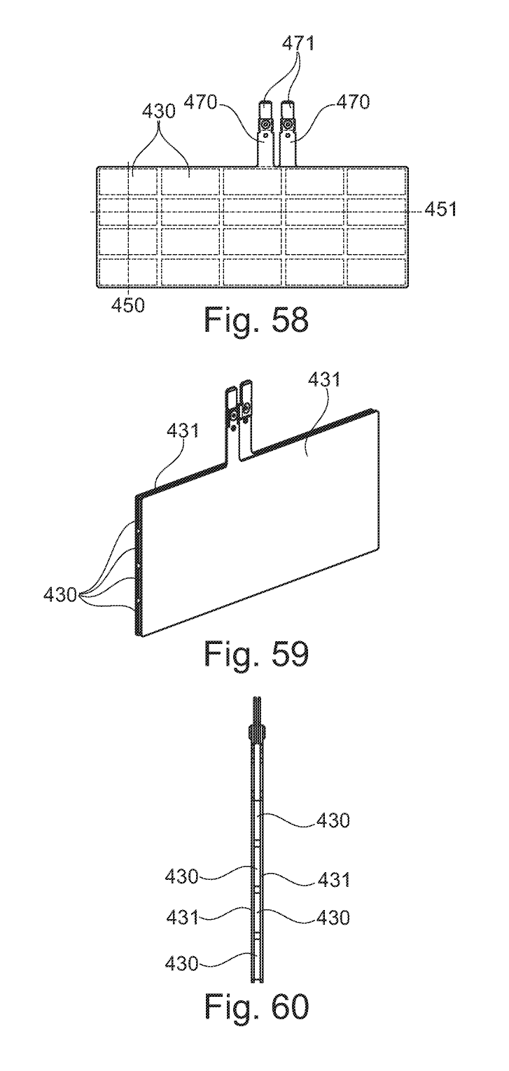

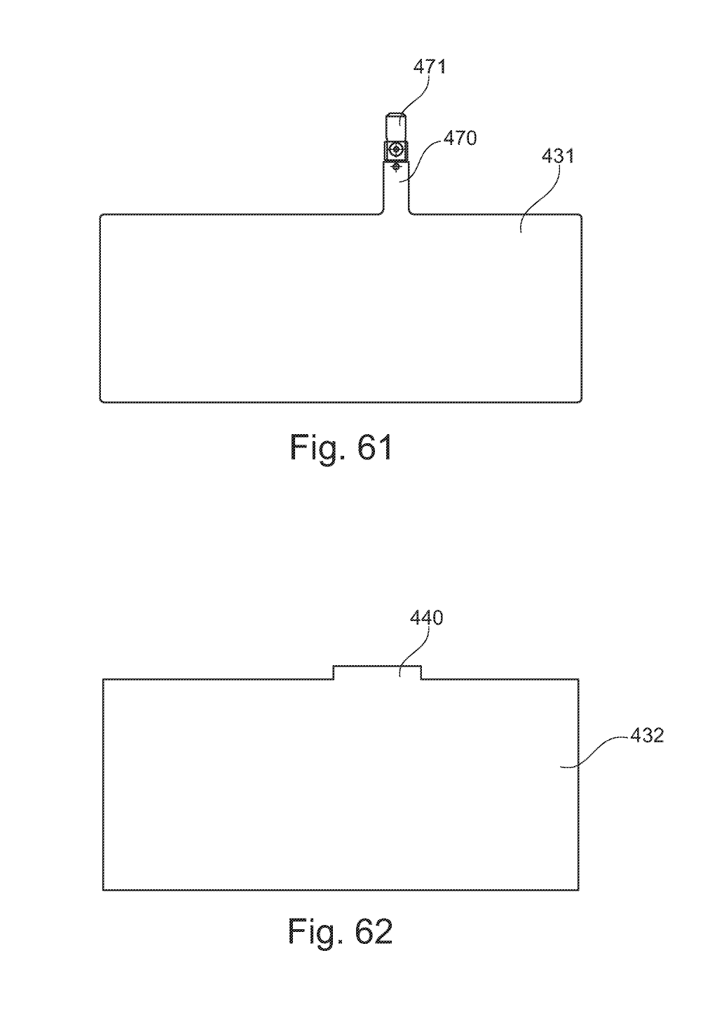

In FIGS. 56 and 58, it can be seen that heater 430 are disposed between the contact elements 431 in columns 450 and rows 451. Here, FIG. 56 shows an arrangement having five columns 450 and four rows 451. These heater 430 are contacted on both sides by only one contact element 431, respectively, so that all the heater 430 can be flowed through in parallel with electric power and heated. Other arrangements of heater 430 can also be provided, that is, a different number of columns and/or rows, depending on the size of the heater 430 and the available space.

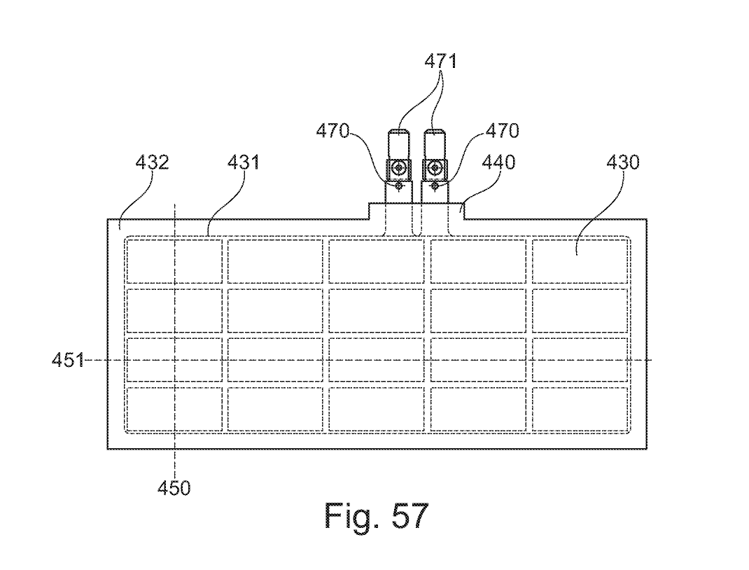

FIG. 57 shows the arrangement of the heater 430 in rows and columns, which are contacted by the contact elements, wherein the arrangement of the heater 430 is insulated on both sides from the electrical insulation 432 by the mutual contact elements 431.

The electrical insulators 432 are formed as approximately rectangular plates, which have a rectangular protrusion 440, which protrudes into the passage 412. The contact elements 431 have terminal lugs 470 which project perpendicularly from the two-dimensional contact elements. Connection elements 471 are arranged at the end portions of the terminal lugs 470, which may be riveted, for example, to the terminal lug.

FIG. 57 shows that for the arrangement of the heater 430, in each case only one contact element 431 is provided on both sides. As an alternative, a plurality of contact elements 431 may be provided on both sides of the heater 430 so as to collectively energize groups of heater, which is not shown.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electric heating device comprising:
a housing with a fluid inlet and with a fluid outlet, the housing being adapted to be flowed through by a fluid; and
at least two heating elements configured to project into an interior of the housing, the at least two heating elements each having a heating element housing and at least one heater arranged in the heating element housing,
wherein the at least one heater has contacting contact elements and an electric insulation to insulate the contact elements from the heating element housing,
wherein the at least two heating elements are sealingly connected with their heating element housing to the housing, and
wherein the heater of the heating elements are arranged in a geometrical configuration between the contact elements.

2. The electric heating device according to claim 1, wherein a heater has a substantially two-dimensional shape, and wherein components of the heater are arranged in columns and in rows.

3. The electric heating device according to claim 2, wherein the components of heater of the heating element are arranged in at least one column and in at least one row.

4. The electric heating device according to claim 2, wherein the components of the heater of the heating element are arranged in at least N columns and in at least M rows with N=1 or more and with M=0 or more.

5. The electric heating device according to claim 4, wherein the components of the heater of the heating element are arranged in 5 columns and in 4 rows or in 1 column and in 5 rows or in 3 columns and in 5 rows or in 2 columns and in 6 rows or in 4 columns and in 4 rows or in 4 columns and in 3 rows or in 7 columns and 2 rows.

6. The electric heating device according to claim 1, wherein the contact elements are configured two-dimensionally, said heaters being contacted on both sides by a contact element.

7. The electric heating device according to claim 6, wherein a two-dimensional contact element is designed such that in each case a two-dimensional contact element contacts the heater of a heating element on one side.

8. The electric heating device according to claim 6, wherein a two-dimensional contact element is designed such that in each case a two-dimensional contact element contacts the heater of at least one column and/or of at least one row of a heating element on one side.

9. The electric heating device according to claim 1, wherein a heater comprises two contact surfaces, which are each contacted by a contact element.

10. The electric heating device according to claim 1, wherein the contact elements have terminal lugs via which they project from the heating element housing of the heating element.

11. The electric heating device according to claim 1, wherein the heating element housing has two shells or two half shells.

12. The electric heating device according to claim 1, wherein the heating element housing is sealingly connected to the housing via a thermal joining process, such as by welding, soldering and/or adhesive bonding.

13. The electric heating device according to claim 1, wherein the at least one heater comprises a PTC element.

14. The electric heating device according to claim 1, wherein the at least one heater consists of a PTC element.
